(19) United States
(12) Patent Application Publication
(10) Pub. No.: US 2007/0214182 A1
(43) Pub. Date: Sep. 13, 2007

(54) ESTABLISHMENT-BASED MEDIA AND MESSAGING SERVICE

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/749,134

(22) Filed: May 15, 2007

Related U.S. Application Data
(63) Continuation-in-part of application No. 11/223,368, filed on Sep. 9, 2005.
(63) Continuation-in-part of application No. 11/425,990, filed on Jun. 22, 2006.
(63) Continuation-in-part of application No. 11/285,534, filed on Nov. 22, 2005.
(63) Continuation-in-part of application No. 11/533,037, filed on Sep. 19, 2006.
Application No. 11/533,037 is a continuation-in-part of application No. 11/223,368, filed on Sep. 9, 2005.
Application No. 11/533,037 is a continuation-in-part of application No. 11/285,534, filed on Nov. 22, 2005.
(63) Continuation-in-part of application No. 11/676,298, filed on Feb. 18, 2007.
(63) Continuation-in-part of application No. 11/697,732, filed on Apr. 8, 2007.
(60) Provisional application No. 60/898,375, filed on Jan. 30, 2007.
(60) Provisional application No. 60/644,417, filed on Jan. 15, 2005.
(60) Provisional application No. 60/731,180, filed on Oct. 29, 2005.
(60) Provisional application No. 60/648,197, filed on Jan. 27, 2005.
(60) Provisional application No. 60/665,291, filed on Mar. 26, 2005.
(60) Provisional application No. 60/651,771, filed on Feb. 9, 2005.
(60) Provisional application No. 60/720,071, filed on Sep. 23, 2005.
(60) Provisional application No. 60/809,951, filed on May 31, 2006.
(60) Provisional application No. 60/902,978, filed on Feb. 22, 2007.
(60) Provisional application No. 60/897,555, filed on Jan. 26, 2007.

(51) Int. Cl. G06F 17/30

(52) U.S. Cl. 707/104.1

(57) ABSTRACT

Methods and Apparatus for enabling groups of patrons of localized physical establishments, such as restaurants and retail stores, to collaboratively select the sequence of musical media for public play. Some embodiments comprise receiving, at a centralized media server, a plurality of media request over a network from a plurality of separate personal portable computing devices, such as mobile phones. Each media request may comprise a media identifier, an establishment identifier and a customer identifier. In response to receiving such media requests, the centralized media server updates a listing of media files pending for play within a localized physical establishment associated with the establishment identifier. The centralized server also provides messaging functions, returning information to the portable computing devices of participating patrons, the information including for example, textual song dedications, song title and artist information, playlist lengths, and song popularity information.

This application claims the benefit of U.S. Provisional Patent Application No. 60/898,375 filed Jan. 30, 2007, which is incorporated in its entirety herein by reference.

This application is a continuation-in-part of U.S. patent application Ser. No. 11/223,368 filed Sep. 9, 2005, which claims the benefit of U.S. Provisional Patent Application No. 60/644,417 filed Jan. 15, 2005, both of which are incorporated in their entirety herein by reference.

This application is also a continuation-in-part of U.S. patent application Ser. No. 11/425,990 filed Jun. 22, 2006, which claims the benefit of U.S. Provisional Patent Application No. 60/731,180 filed Oct. 29, 2005, both of which are incorporated in their entirety herein by reference.

This application is also a continuation-in-part of U.S. patent application Ser. No. 11/285,534 filed Nov. 22, 2005, which claims the benefit of the above-referenced U.S. Provisional Patent Application Nos. 60/648,197 and 60/665,291, and which also claims the benefit of U.S. Provisional Patent Application No. 60/651,771 filed Feb. 9, 2005, all of which are incorporated in their entirety herein by reference.

This application is also a continuation-in-part of U.S. patent application Ser. No. 11/533,037 filed Sep. 19, 2006, which is a continuation-in-part of the above-referenced U.S. patent application Ser. Nos. 11/223,368 and 11/285,534, and which also claims the benefit of U.S. Provisional Patent Application No. 60/720,071 filed Sep. 23, 2005, all of which are incorporated in their entirety herein by reference.

This application is a continuation-in-part of U.S. patent application Ser. No. 11/676,298 filed Feb. 18, 2007 which claims the benefit of U.S. Provisional Patent Application No. 60/809,951 filed May 31, 2006, both of which are incorporated in their entirety herein by reference.

This application also claims benefit of U.S. Provisional Patent Application No. 60/902,978 filed Feb. 22, 2007, which is incorporated in its entirety herein by reference.

This application is a continuation-in-part of U.S. patent application Ser. No. 11/697,732 filed Apr. 8, 2007, which claims the benefit of U.S. Provisional Patent Application No. 60/897,555 filed Jan. 26, 2007, both of which are incorporated in their entirety herein by reference.

### BACKGROUND OF THE INVENTION

1. Field of the Invention

The present invention relates generally to media file selection systems that enable a plurality of users to individually select media items for play within a localized physical establishment. More specifically, the present invention relates to a distributed method by which a plurality of users of individual portable computing devices may wirelessly add media files to a listing of media files to be played within a particular physical establishment.

2. Discussion of the Related Art

In recent years wireless phones and other similar portable wireless communication devices have become a nearly universally carried by people around much of the world.

Despite the fact that most people in the industrialized world today who visit physical establishments such as restaurants, bars, gyms, and clubs, enter those establishments equipped with at least one portable wireless communication device upon their person, new technologies are needed that enable the patrons of such physical establishments to selectively influence the environment of that establishment via a portable computing device.

### SUMMARY OF THE INVENTION

Several embodiments of the invention advantageously address the needs above as well as other needs by enabling users, upon entry of physical establishments, to selectively influence the environment of that establishment by entering data into their portable computing device. In addition, several embodiments of the invention enable users, while inside an establishment, to receive and review establishment-related messages upon their portable computing devices.

In some embodiments, the invention can be characterized as a distributed media selection system for patrons of localized physical establishments comprising: an establishment media server coupled to a network, the establishment media server comprising: a processor; and a computer readable storage medium coupled to the processor, the computer readable storage medium comprising: a first database component having retrievably stored therein a plurality of media playlist queues, each media playlist queue associated with at least one localized physical establishment, the localized physical establishment having a unique establishment identifier associated therewith, each media playlist queue comprising a listing of media files selected for play within the associated localized physical establishment, each of the media files selected for play having a unique media identifier associated therewith, and a second database component having retrievably stored therein a media menu associated with the localized physical establishment, the media menu comprising a listing of media files available for selection within the localized physical establishment, each of the media files available for selection having a unique media identifier associated therewith; wherein the processor is adapted to: receive over the network a plurality of media requests, each from a separate personal portable computing device, each media request including a media identifier, an establishment identifier, and a patron identifier, update each media playlist queue by adding an indication of the media file associated with the received media identifier to the listing of media files selected for play within the localized physical establishment associated with the received establishment identifier, and cause the contents of each media file to be publicly played by a media player within a localized physical establishment associated with the media playlist queue.

In some embodiments, the invention can be characterized as a method of distributed media selection for localized physical establishments comprising receiving a media request over a network from a personal portable computing device, the media request comprising a media identifier, an establishment identifier and a customer identifier; updating a media playlist queue associated with the establishment identifier, the updating comprising adding a media file associated with the media identifier to a listing of media files pending for play within a localized physical establishment associated with the establishment identifier; and outputting the contents of the media file as music at the localized physical establishment.

In some embodiments, the invention can be characterized as a component of an establishment server comprising a processor adapted to receive at least a first and a second media request over a network, the first and second media requests being received from a first and a second personal portable computing device respectively, each media request comprising a media identifier, an establishment identifier and a customer identifier; update a media playlist queue associated with each establishment identifier, the updating comprising adding a media file associated with the media identifier to a listing of media files pending for play within a localized physical establishment associated with each establishment identifier; and cause the output of the contents of each media file as music at a localized physical establishment associated with each media request.

In some embodiments the invention provides a media dedication feature in which a first patron may select a media file for public play within an establishment and dedicate that selection to second patron. In some such embodiments a dedication message is sent from the establishment media server to a portable computing device of the second patron.

In some embodiments the invention provides a time-delayed media dedication feature in which a first patron may select a media file for public play within an establishment, dedicate that selection to second patron, and have that the media file play the next future time when the second patron is determined or presumed to be present within the establishment.

In some embodiments the invention provides a media information function in which a patron may request information from the establishment media server about the number of songs on a currently pending playlist for a particular establishment, the play time of a currently pending playlist for a particular establishment, the title and/or artist of a currently playing song within a particular establishment, the popularity of a currently playing song within a particular establishment, the ID of the requester of a currently playing song within a particular establishment, and/or the rating values provided for a currently playing media file within a particular establishment by other patrons within the particular establishment.

In some embodiments a patron may pay a fee to have a media selection be assigned higher priority on a pending playlist for a particular localized physical establishment as compared to other media selections.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 depicts a generalized block diagram of an establishment media player of the present invention;

FIG. 2 depicts a generalized block diagram of the system of the invention including an establishment media server, an establishment media player, and a plurality of portable computing devices, all communicating by wireless communication link;

FIG. 3 depicts another block diagram of the system of the present invention including an establishment media server that is communication through an intervening network with the establishment media player and a portable communication device that is in wireless communication with one or both of the establishment media server and the establishment media player;

FIG. 4 depicts an example Media Menu of the present invention as it might be printed upon a physical paper document and distributed to patrons within an establishment;

FIG. 5 depicts an example display screen of the present invention as it might present the currently pending playlist of an establishment in a prominent location of that establishment, for example hanging upon a wall behind or over the bar.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

The present invention addresses the needs above by enabling users, upon entry of physical establishments, to selectively influence the environment of that establishment by entering data into their portable computing device. In a prior invention by the present inventor, as disclosed in U.S. patent application Ser. No. 11/422,065 filed Jun. 6, 2006 and hereby incorporated by reference, patrons of a physical establishment such as a restaurant may request a waiter to come to their table, to refill drinks, to bring a bill, or to bring more bread to their table, by entering data into a wireless portable computing device on their person. In other prior inventions by the present inventor, as disclosed in the above-mentioned U.S. patent application Ser. Nos. 11/223,368 and 11/533,037, both of which have been incorporated by reference, groups of users, each with their own portable computing device, are enabled to use their own portable computing devices to collaboratively select a sequence of playing musical media files that is played to the group. What is needed however, as disclosed in this continuation of the aforementioned applications, are additional methods by which patrons of a localized physical establishment may easily influence the establishment as well as additional methods by which groups of users may collaboratively select sequences of playing music for shared listening. More specifically, what is needed are additional methods, apparatus, and computer program products by which the patrons of a localized physical establishment may more easily and collaboratively select the musical media files that are played within the physical establishment by each entering data into a wireless portable computing devices upon their person. What is also needed is are additional distributed hardware and software architectures that enables such services to be provided within a plurality of separate restaurants, bars, gyms, and other physical establishments using a remote offsite server that is maintained by a service provider. What is also needed is are additional methods by which patrons of a particular establishment can be easily billed for selecting musical media for play within that localized physical establishment. What is also needed are advanced interaction features that enable a user to pay extra to have the media file be played sooner within the establishment, to receive information about how long the wait is until his or her media selection is played, to enable patrons within an establishment to rate currently playing media, to enable a patron within an establishment to dedicate a media selection to another patron, to enable patrons within an establishment to request information about currently playing media file, and/or enable patrons within an establishment to buy for their own the digital media file associated with a currently playing song within a particular localized physical establishment. As disclosed herein, the present invention addresses these and other needs.

Provided herein is a system, method, and computer program product which enables the patrons of a localized physical establishment to select specific musical media files to be played within that establishment by entering data into a wireless portable computing device on their person. Upon entering a media file selection into a portable computing device, a message is sent over a wireless link to an establishment media server which maintains a playlist for the establishment. In some embodiments the establishment media server may be located upon the premises of the localized physical establishment. In a preferred embodiment the establishment media server is a remote server that maintains separate media playlists for a plurality of localized physical establishments over a large geographic area. In some embodiments the wireless portable computing device is a phone device and the message is sent to the establishment media server as a text message. In some such embodiments the text message encodes the media item selected by the patron as well as the establishment ID that identifies the particular localized physical establishment for which the media selection is to be associated. In this way the establishment media server receives an indication of a particular media selection as well as a particular localized physical establishment to which that media selection is associated. The establishment media server may then add the particular media selection to a playlist associated with that particular localized physical establishment. In this way a plurality of separate users may selectively use portable computing devices upon their person to each add specific musical media file selections to a playlist for a particular localized physical establishment. The playlist is then used to sequentially play musical media files through speakers within the establishment such that the patrons of that establishment can publicly listen to the music selected by the plurality of separate patrons.

Because a physical establishment such as a restaurant or gym may not want users to select inappropriate media items for play in that establishment, a musical media menu may be provided, either electronically or physically, to patrons of an establishment such that they may only select media items off that musical menu when adding media items to the playlist of that localized physical establishment. For example, in one embodiment an establishment provides a printed menu of media items upon each table of the establishment, the printed menu of media items including the names of the media items (i.e. the names of the songs) and with a unique ID value for that song. In addition other information may be provided on the printed listing, for example the artist of each media item, the album of that media item, and a date for that media item. In this way each table within the establishment may be provided with a visual menu of a plurality of available media items from which the user may select. A user may then view the unique ID value associated with the media item, enter it into his or her portable computing device as a means of selecting it, and then send a wireless communication message to the establishment media server for that particular establishment indicating a desire to play that particular media item to the establishment. In this way the establishment media server may add that particular media item to the playlist for that particular localized physical establishment. It should be noted that while the printed menu of media items is described above as being located upon each table, it may also be printed or otherwise visually displayed upon walls, floors, or other surfaces of the establishment. It may be displayed as printed media or as electronically projected media.

In some embodiments the menu of available media items is sent electronically to the portable computing device of patrons over a wireless communication link within the establishment. In some such embodiments a user may enter a unique establishment ID code into his or her portable computing device, the code identifying the unique establishment that he or she has just entered. This may be conceptualized as a novel “tell us you're here” methodology in which a patron sends an electronic message to the establishment server indicating his or her current presence within a particular establishment, identified by unique establishment ID. In some such embodiments the user must enter a unique password for that establishment as well. In response to entering the unique establishment ID, the portable computing device may then receive and/or download part or all of the menu of media items and view them within the portable computing device. The user may then select an item from the electronic listing within the portable computing device using traditional GUI interface interactions. In this way a user may enter an establishment, receive a unique ID and/or password for that establishment (either visually or electronically), and using that ID and/or password may download a menu of acceptable media items for that localized physical establishment. The patron may then select one or more media items from that menu of media items. An indication of the selection is sent to the establishment media server, generally along with the unique ID and/or password for that particular establishment. The establishment media server may then add that media selection to the playlist for that particular localized physical establishment. The establishment media server may also bill the user who made the selection for the selection, for example charging the user 20 cents for the selection. The message may be sent to the establishment media server as a text message and may be billed through standard text messaging billing processes. In some such embodiments a reverse billing sms process is used in which the media selection fee is added to the patrons phone bill and/or text messaging bill. In some embodiments the localized physical establishment is assigned a portion of the billed price. In this way a localized physical establishment may have a monetary incentive to enable such a service within their establishment (i.e. their restaurant, bar, gym, coffee house, or retail store).

The present invention provides for advanced features in which: (a) a patron of a particular establishment is enabled pay a higher fee to cause his or her media selection to be skipped ahead of previously pending items on a playlist for that establishment, (b) a patron of a particular establishment is enabled to selectively pay an incrementally higher fee to cause his or her media selection be assigned an incrementally higher priority level, the priority level being used to order songs within the pending playlist queue, (c) the establishment media server is enabled to send a message to the portable computing device of a patron of an establishment indicating the number of pending media selections within a current playlist for that establishment, (d) the establishment media server is enabled to send a message to the portable computing device of a patron of an establishment indicating the total time of media play pending in a current playlist for that establishment, (e) the patrons of an establishment may send rating data to the establishment media server relating to a media item currently playing within an establishment, the establishment media server tallying the rating data from patrons and providing a statistical compilation back to patrons of the establishment, (f) a patron of a particular establishment may send a request to the establishment media server asking for descriptive information about a currently playing media item, the establishment media server responding by sending information indicative of a title, artists, and/or date of the currently playing media item to the portable computing device of the requesting patron, (g) a patron of a particular establishment may send a request to the establishment media server asking to purchase a currently playing media item, the establishment media server responding by enabling the fee-based download of the media file by the portable computing device of the requesting patron, and (h) a particular establishment may receive monetary compensation for media files purchased by patrons of that establishment in response to the media file being played through the speaker of that establishment, (i) a trivia game in which the patrons of an establishment may be awarded points for successfully indicating through their portable computing device their knowledge of the title, artists, and/or date of a media file currently playing through the speakers of the establishment, (j) a data collection and presentation system in which users can view the most popular songs played within a location based physical establishment over a particular period of time, (k) a dedication process in which a patron may not only select a particular media item for play within an establishment, but may also dedicate the media file to another patron, (l) a media withdrawal process in which a patron may request that a pending media selection which was previously sent in by that patron, but not yet played within the target establishment, be withdrawn from the pending queue in exchange for an awarded credit for a future media selection by the patron, and (m) a media termination process in which a playing media file may be ceased from playing prior to full completion within an establishment based at least in part upon a tally of patron partiality rating data for the playing of that song within that establishment, being determined to be below a certain value level, and (n) a promotional messaging process in which a patron is enabled to make a free media selection for play within a particular establishment in exchange for receiving an establishment-specific promotional message sent from the establishment media server to the portable computing device of that patron, the establishment-specific promotional message providing information content about a product or service of the particular establishment.

As discussed in Apple Computer, Inc., U.S. Patent Publication No. 2004/0224638 A1 to Fadell, et al., which is herein incorporated by reference in its entirety; an increasing number of consumer products are incorporating circuitry to play musical media files and other electronic media. Such technologies are generally referred to as media players and enable large numbers of musical media files to be stored in an electronic memory and selectively accessed for play through an audio output. Often physical establishments employ media playing devices to play musical media to the patrons of those establishments through speakers mounted in the walls and/or ceiling of the establishment. In common embodiments a digital playlist or other digital sequencing of musical media files may define the sequence of musical media content (i.e. songs) that are played to the patrons of a physical establishment through the speakers of that establishment. In some embodiments the musical media is stored locally within an electronic memory on the premises of the establishment and are selectively accessed for play to the patrons of that establishment using a preplanned playlist, an automated selection process, and/or a combination of the aforementioned. In other embodiments the musical media files are stored on a remote server that is not on the premises of the localized physical establishment and are received over a communication link for play to the patrons of that establishment through speakers within the premises of that localized physical establishment. Whichever architecture is employed, hardware and software infrastructure currently exists that enables musical media to be played to patrons of an establishment based upon preplanned sequencing of musical media files and/or based upon an automated selection, for example randomized selection, of musical media files.

The present invention provides a significant benefit to such current infrastructure, enabling a plurality of patrons of a localized physical establishment, each with a wireless portable computing device on their person, to jointly select the sequence of musical media files that are played within an establishment by entering data into the wireless communication device of that patron. In a common embodiment the wireless communication device is a wireless phone that is configured to send and receive data to a remote server over a communication network, the remote server being an establishment media server of the present invention. In this way a patron of a localized physical establishment such as a restaurant, bar, gym, or retail store, may use their wireless communication device (i.e. their phone) to select media items that are added to a pending playlist of media items to be played within the localized physical establishment. In a common embodiment patrons send a text message to the establishment media server, the text messaging indicating the establishment for which the user desires to add a media item to a pending localized establishment playlist, AND indicating the media item desired to be added to that playlist. In some embodiments the user may also download an establishment specific media menu to his or her portable computing device, the media menu indicating a set of media files from which a selection may be made for addition to the establishment-specific playlist from the establishment media server. In some embodiments the user may download the current playlist from the establishment media server, for viewing on his or her portable computing device (i.e. phone) as it is currently pending for play to the particular establishment. The present invention is configured such that an establishment media player outputs songs to patrons of a localized physical establishment through speakers of the establishment, the playing media being orchestrated by a playlist (or other sequencing of media content) maintained by an establishment media server. The present invention also provides method and apparatus by which patrons can be easily billed for adding musical media selections to the sequence of musical media selections being played to the patrons of a particular localized physical establishment. The present invention also provides for methods and apparatus by which a localized physical establishment may define a specific set of musical media files from which patrons are authorized to select musical media, the set of musical media files being referred to herein a musical Content menu. The present invention also provides for a password protection method helping to ensure that only substantially current patrons of a localized physical establishment may make musical media selections for that establishment. Where necessary, computer programs, algorithms and routines are provided, programmed in a high level language computing language, for example Java™ C++, C#, or Visual Basic™.

The present invention generally operates by using a unique media ID for each media item that may be added to a playlist, the unique media ID identifying the particular media item which is generally a particular song by a particular artist. The present invention also generally operates by using a unique establishment ID for each enabled establishment, the unique establishment ID indicating a particular localized physical establishment such as a restaurant, bar, retail store, or gym, within the real physical world. The present invention also operates by maintaining establishment-specific playlists, an establishment specific playlist being a sequenced listing of particular media items (for example by each of their unique media ID value) that is scheduled or otherwise ordered for play within a particular localized physical establishment. That an establishment specific playlist is generally relationally associated with a particular unique establishment such as a particular restaurant, bar, cub, or gym within the real physical world. The present invention also generally operates by using a unique user ID for each user of a portable computing device of the present invention, the unique user ID identifying the specific user (or the specific portable computing device of the user), such that the unique user may be uniquely billed for making selections that are added to an establishment-specific playlist of a particular unique establishment.

Thus the present invention generally operates by maintaining an establishment media server (199), the establishment media server maintaining establishment-specific playlists for one or more unique establishments within the real physical world. In a preferred embodiment the establishment media server is the server of a large service provider and is configured to maintain establishment-specific playlists for a large plurality of unique establishments, each establishment-specific playlist being relationally associated with the establishment ID of that unique establishment. The present invention also generally operates by enabling a plurality of portable computing devices (100) of a plurality of users to independently communicate with the establishment media server and make media selections that are added to a particular establishment playlist. In this way a plurality of users who are visiting a particular establishment may jointly make additions to the playlist for that establishment, each user employing their own portable computing device. The establishment media server is generally in communication with an establishment media player (198) for each particular establishment for which it maintains an establishment specific playlist. In this way the establishment media server may send information to the establishment media player of a particular establishment, thereby causing the establishment media player of that establishment to play media in accordance with an establishment-specific playlist that is associated with that establishment.

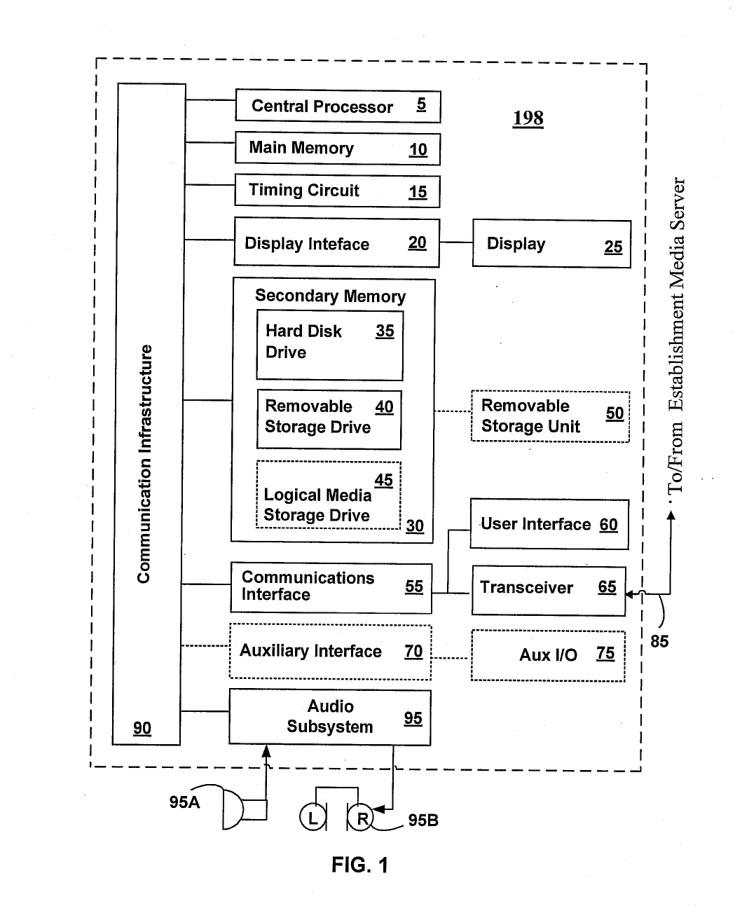

Referring to FIG. 1, a generalized block diagram of an establishment media player 198 is depicted. The establishment media player 198 includes a communications infrastructure 90 used to transfer data, memory addresses where data files are to be found and control signals among the various components and subsystems associated with the establishment media player 198.

A central processor 5 is provided to interpret and execute logical instructions stored in the main memory 10. The main memory 10 is the primary general purpose storage area for instructions and data to be processed by the central processor 5. The term “main memory” 10 is used in its broadest sense and includes RAM, EEPROM and ROM.

A timing circuit 15 is provided to coordinate activities within the media player in near real time. The central processor 5, main memory 10 and timing circuit 15 are directly coupled to the communications infrastructure 90.

A display interface 20 may be provided to drive a display 25 associated with the establishment media player 198. The display interface 20 is electrically coupled to the communications infrastructure 90 and provides signals to the display 25 for visually outputting both graphical displays and alphanumeric characters.

The display interface 20 may include a dedicated graphics processor and memory to support the displaying of graphics intensive media. The display 25 may be of any type (e.g., cathode ray tube, gas plasma) but in most circumstances will usually be a solid state device such as liquid crystal display.

A secondary memory subsystem 30 is provided which houses retrievable storage units such as a hard disk drive 35, a removable storage drive 40, an optional logical media storage drive 45 and an optional removal storage unit 50. One skilled in the art will appreciate that the hard drive 35 may be replaced with flash memory.

The removable storage drive 40 may be a replaceable hard drive, optical media storage drive or a solid state flash RAM device. The logical media storage drive 45 may include a flash RAM device, an EEPROM encoded with playable media, or optical storage media (CD, DVD). The removable storage unit 50 may be logical, optical or of an electromechanical (hard disk) design. A communications interface 55 subsystem is provided which allows for standardized electrical connection of peripheral devices to the communications infrastructure 90 including, serial, parallel, USB, and Firewire™ connectivity. For example, a user interface 60 and a transceiver 65 are electrically coupled to the communications infrastructure 90 via the communications interface 55. For purposes of this specification, the term user interface 60 includes the hardware and operating software by which a user interacts with the establishment media player 198 and the means by which the media player conveys information to the user and may include the display interface 20 and display 25.

Because the establishment media player 198 is a player that is providing music to localized physical establishment such as a restaurant, the user interface 60 is generally configured for employees of that restaurant, for example enabling the employees to adjust the volume of the media player as it outputs media across the restaurant.

The transceiver 65 facilitates the remote exchange of data and synchronizing signals between the establishment media player 198 and other devices in processing communications 85 with the establishment media player 198. As disclosed herein, said other devices include an establishment media server 199 that maintains an establishment specific playlist for the establishment. The establishment media server may be configured as part of the same hardware as the establishment media player, but in most preferred embodiments is a remote server that is maintained by a service provider and is located off the grounds of the localized physical establishment. In some embodiments establishment media player 198 communicates with the establishment media server 199 over a communication network such as the internet. The communication link may be wired, wireless, or a combination of wired or wireless.

The transceiver 65 may also facilitate the remote exchange of data between the establishment media player and plurality of portable computing devices (100) on the persons of individuals, each of said personal information devices being associated with a user and generally containing personal data about that user. In some embodiments the transceiver 65 is a radio frequency type normally associated with computer networks for example, wireless computer networks based on BlueTooth™ or the various IEEE standards 802.11ₓ, where x denotes the various present and evolving wireless computing standards, for example WiMax 802.16 and WRANG 802.22. Alternately, digital cellular communications formats compatible with for example GSM, 3G, CDMA, TDMA and evolving cellular communications standards. Both peer-to-peer (PPP) and client-server models are envisioned for implementation of the invention. In a third alternative embodiment, the transceiver 65 may include hybrids of computer communications standards, cellular standards and evolving satellite radio standards, as well as landlines.

The user interface 60 employed on the establishment media play 198 may include a pointing device (not shown) such as a mouse, thumbwheel or track ball, an optional touch screen (not shown); one or more push-button switches 60A, 60B; one or more sliding or circular rheostat controls (not shown) and one or more other type switches (not shown.) The user interface 60 provides interrupt signals to the processor 5 that may be used to interpret user interactions with the establishment media player 198 and may be used in conjunction with the display interface 20 and display 25. One skilled in the art will appreciate that the user interface devices which are not shown are well known and understood. In this way employees of the establishment may interact directly with the establishment media player and input configuration information.

Lastly, an audio subsystem 95 is provided and electrically coupled to the communications infrastructure 90. The audio subsystem provides for the output of digital media, for example, multi or multimedia encoded in any of the exemplary formats MP3, AVI, WAV, MPG, QT, WMA, AIFF, AU, RAM, RA, MOV, MIDI, etc. The audio subsystem may include a microphone input port 95A for input of voice commands. The audio subsystem also includes an audio output port 95B which may output musical media to speakers, headphones, or other sound producing devices. In most preferred embodiments the audio output port 95b is connected to a plurality of speakers located around the localized physical establishment, for example mounted within or upon the ceiling and/or walls of the establishment. Connection of the microphone 95A and/or speakers 95B includes both traditional cable and wireless arrangements such as BlueTooth™ are known in the relevant art

In addition, the audio subsystem is envisioned to optionally include features such as graphic equalization, volume, balance, fading, base and treble controls, surround sound emulation, and noise reduction. One skilled in the art will appreciate that the above cited list of file formats is not intended to be all inclusive.

The establishment media player 198 includes an operating system, the necessary hardware and software drivers necessary to fully utilize the devices coupled to the communications infrastructure 90, media playback and recording applications, data access routines for sending and/or receiving data from the establishment media server 199 and/or from portable computing devices 100.

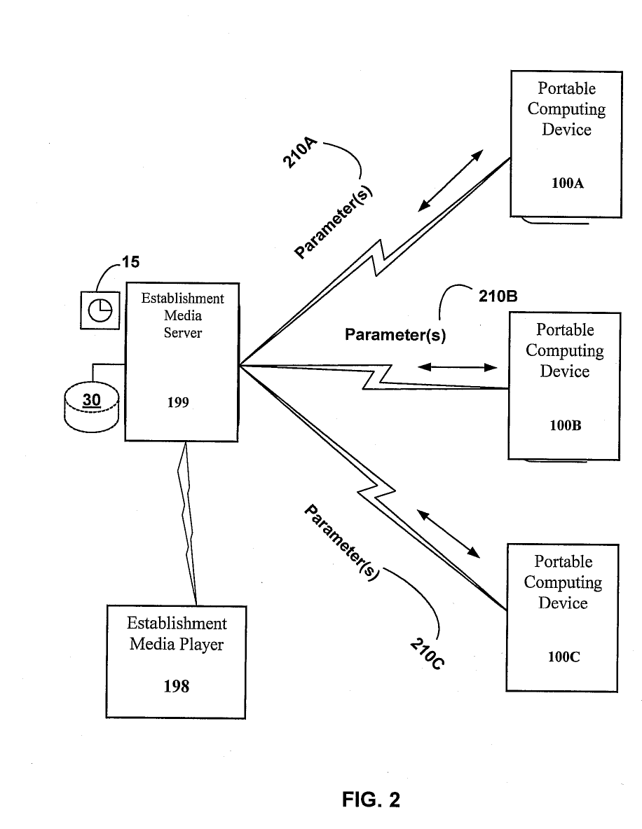

Referring to FIG. 2, a generalized block diagram is depicted for the present invention including the establishment media player 198, the establishment media server 199, and a plurality of wireless portable computing devices 100A, 100B, and 100C, which may be for example wireless phones of the persons of patrons of an establishment. In general there may be a plurality of establishment media players 198 in each of a plurality of unique localized physical establishments, each in communication with a single establishment media server 199, although shown in FIG. 2 is only a single establishment media player 198. Thus FIG. 2 is meant to represent the system as it relates to a single localized physical establishment, including the establishment media player 198 for that particular establishment and a plurality of portable computing devices 100A, 100B, and 100C for a plurality of current patrons of that localized physical establishment.

As shown in the figure, each portable computing device is configured to exchange data with the establishment media server. This data may include media selections made by a user of a portable computing device for a particular establishment, the media selections being received by the establishment media server and being added to the unique playlist for that particular establishment. The data may also include a media menu of available media files for a particular establishment, the media menu being sent from the establishment media server 198 to the portable computing devices 100 that are within that particular establishment (or have otherwise been identified as being associated with that particular establishment). The data may also include part or all of a current establishment-specific playlist of a particular establishment being sent from the establishment media server 199 to the portable computing devices 100 that are within that particular establishment (or have otherwise been identified as being associated with that particular establishment). In addition, although not shown, the portable computing devices 100 and the establishment media player 198, may exchange data directly.

As also shown in the figure, the establishment media player 198 of a particular establishment is in communication with the establishment media server 199 and exchanges data there between. In this way the establishment media server may send playlist information and/or may send media content consistent with a stored playlist to the establishment media player 198. This is how the establishment media server may be operative to orchestrate the media content that is played by the establishment media player 198 such that it is consistent with a stored establishment-specific playlist.

In general the actual media content of media files may be stored upon the establishment media server and streamed to the establishment media player, although this is bandwidth intensive, especially if the establishment media server is in communication with a plurality of establishment media players. Instead the actual media content of media files may be stored locally to the establishment media player 198 and is accessed by the establishment media player 198 in accordance with the requirements of the establishment specific playlist for that establishment as it is maintained by the establishment media server 199. In such embodiments the establishment media server may simply send unique media ID values to the establishment media player 198 indicating by unique ID which media items are to be played at what times (or in what order) to be consistent with the establishment specific playlist for that establishment. In other embodiments the whole playlist is communicated to the player 198.

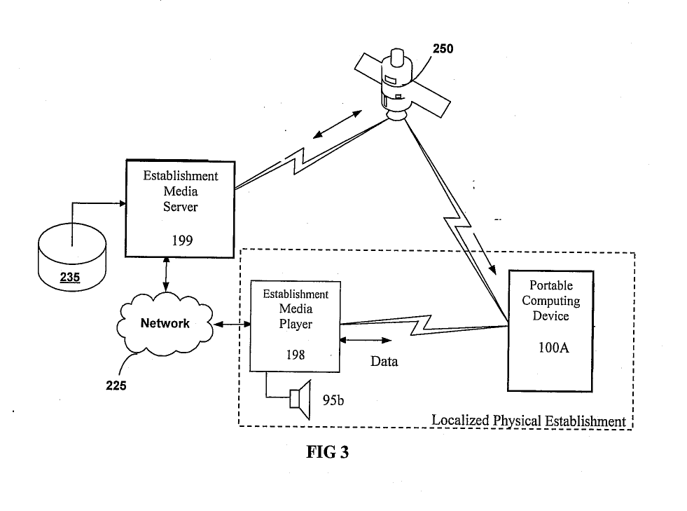

Referring next to FIG. 3 an alternate block diagram is shown indicating the boundaries of a localized physical establishment (as shown by the dotted line). Inside the boundaries is an establishment media player 198 that is connected to a speakers 95a that are located around the localized physical establishment. The establishment media player 198 communicates over a network, for example the Internet, with the establishment media server 199. In addition at least one portable computing device 100A is located within the establishment and receives the unique ID for that establishment either by visual display to the user (through a sign) or through electronic communication, for example by an electronic signal from the media player or other electronics associated with the unique localized physical establishment. For example the portable computing device may receive the unique ID for the establishment by Bluetooth link, WiFi link, or RFID communication link. Once the portable computing device has the unique ID of the establishment it may communicate that unique ID, along with any media selections, to the media server 199 so as to add media selections to a pending playlist for that unique establishment. As shown in the figure the communication between the portable computing device 100A and the establishment media server 199 may be over wireless link, for example through an intervening satellite 250.

Thus through the interactions of the establishment media server 199, the establishment media player 198, and a plurality of portable computing devices 100, a system, method, and computer program product is provided which enables the patrons of a localized physical establishment to select specific musical media files to be played within that establishment by entering data into a wireless portable computing device on their person. In one embodiment, a user who is located within a particular establishment enters a media selection into his or her portable computing device 100. Upon entering a media file selection into the portable computing device 100, a message is sent over a wireless link to the establishment media server 199 which maintains a unique playlist for the particular establishment. In some embodiments the wireless portable computing device is a phone device and the message is sent to the establishment media server 199 as a text message. In some such embodiments the text message encodes the media item selected by the patron as well as a unique establishment ID that identifies the particular localized physical establishment for which the media selection is to be associated. In this way the establishment media server receives an indication of a particular media selection (generally by unique media ID) as well as a particular localized physical establishment to which that media selection is associated (by unique establishment ID). The establishment media server 199 then adds the particular media selection to a unique playlist associated with that particular localized physical establishment. In this way a plurality of separate users may selectively use their own individual portable computing devices upon their person to add musical media file selections to a unique playlist for a particular localized physical establishment. The playlist is then used by the establishment media player 198 to sequentially play musical media files through speakers within the establishment such that the patrons of that establishment can listen to the music selected by the plurality of separate patrons.

In certain embodiments an establishment specific password or other authentication key must be provided by the portable computing device 100 of a patron for the patron to add a musical media file to the playlist for that establishment at a particular time. By regularly updating the password and only providing the password to current patrons of an establishment, either electronically or physically, the present invention may be configured to only enable substantially current patrons of a physical establishment to add musical media files to a unique playlist of that particular establishment. For example, a regularly updated password may be electronically sent to portable computing devices of the current patrons of a particular establishment to enable those portable computing devices to send valid messages to the establishment media server that enable media items to be added to the playlist for that particular establishment. In some embodiments the password need only be updated daily. In such embodiments the password may simply be written upon a whiteboard, chalk board, printed menu, or other visually viewable medium of the physical establishment. The patron may then view the password, type it into his or her portable computing device, and then be enabled to add media items to the current playlist for that localized physical establishment. Such a password method, whether the password is conveyed to the patrons electronically or visually, may be employed to prevent people who are not current patrons (i.e. who are not currently within or recently visited the localized physical establishment) to add media items to the playlist for that establishment.

In addition, because a localized physical establishment such as a restaurant or gym may not want users to select inappropriate media items for play in that establishment, a musical menu may be provided, either electronically or physically, to patrons of an establishment such that they may only select media items off that musical menu when adding media items to the unique playlist of that particular localized physical establishment. For example, in one embodiment an establishment provides a printed menu of media items upon each table of the establishment, the printed menu of media items including the names of the media items (i.e. the names of the songs) and with a unique ID value for that song. In addition other information may be provided on the printed listing, for example the artist of each media item, the album of that media item, and a date for that media item. In this way each table within the establishment may be provided with a visual menu of a plurality of available media items from which the user may select. A user may then view the unique ID value associated with the media item, enter it into his or her portable computing device as a means of selecting it, and then send a wireless communication message to the establishment media server 199 for that particular establishment indicating a desire to play that particular media item to the establishment. In this way the establishment media server 199 may add that particular media item to the unique playlist for that particular localized physical establishment. It should be noted that while the printed menu of media items is described above as being located upon each table, it may also be printed or otherwise visually displayed upon walls, floors, or other surfaces of the establishment. It may be displayed as printed media or as electronically projected media.

Note, in some embodiments the portable computing device 100 includes an RFID scanner and may receive the unique ID for a particular establishment from an RFID chip that is physically located upon the premises of the establishment. A unique password may also be conveyed in this way.

In some embodiments the menu of available media items is sent electronically to the portable computing device 100 of patrons over a wireless communication link. This may come from a separate computer associated with the establishment or from the establishment media player 198. In common embodiments this comes from the establishment media server 199 over the intervening wireless communication link. In some such embodiments a user may enter a unique establishment ID code into his or her portable computing device, the code identifying the unique establishment that he or she has just entered. This may be conceptualized as a novel “tell us you're here” methodology in which a patron sends an electronic message to the establishment server indicating his or her current presence within a particular establishment, identified by unique establishment ID coded within the electronic message. In some such embodiments the electronic message is an sms text message, the establishment ID coded within the contents of the text message. In some such embodiments the user must also enter a unique password for that establishment as well. In response to sending the unique establishment ID to the establishment server for a particular establishment, the portable computing device may then download part or all of the menu of media items for that particular establishment and view them within the portable computing device from the establishment media server 199. The user may then select an item from the electronic listing within the portable computing device using traditional GUI interface interactions. In this way a user may enter an establishment, receive a unique ID and/or password for that establishment (either visually or electronically), and using that ID and/or password may download a menu of acceptable media items for that localized physical establishment. The patron may then select one or more media items from that menu of media items. An indication of the selection is sent to the establishment media server 199, generally along with the unique ID and/or password for that particular establishment. The establishment media server 199 may then add that media selection to the unique playlist for that particular localized physical establishment. The establishment media server 199 may also bill the user who made the selection for the selection, for example charging the user 25 cents for the selection. The message may be sent to the establishment media server as a text message and may be billed through standard text messaging billing processes. In some embodiments the patron is billed through a reverse billing sms process. In some embodiments the localized physical establishment is assigned a portion of the billed price. In this way a localized physical establishment may have a monetary incentive to enable such a service within their establishment (i.e. their restaurant, bar, gym, or retail store).

In some embodiments the establishment media server 199 streams music to a media player 198 of the establishment for play through the speakers of the establishment based upon the patron suggested playlist that is maintained upon the establishment server. In other embodiments the establishment media server 199 streams media selection ID indicators to a media player 198 of the establishment, the media player then locally accessing the appropriate media file associated with the selection ID and then playing it through the speakers of the establishment. Either way a media player of an establishment is operative to play a sequence of media files to the patrons of the establishment based upon a playlist generated in response to patron media selections conveyed over wireless link from portable computing devices on the person of the patrons. In this way a plurality of current patrons of a localized physical establishment may jointly compose a listing of media items for play to the establishment. In some embodiments the listing is composed in the order in which the selections are received by the establishment media server from patrons. Thus patrons may wireless add musical media selections to the end of a currently active playlist for an establishment by entering data into their wireless portable computing device and sending a digital message to the establishment media server. In common embodiments the patron is billed for the selection, either on a selection by selection basis or for a subscription fee that enables participation over a period of time. The service provided that maintains the establishment media server may provide a portion of the billing, for example based upon the number of selections made within that particular establishment, to the establishment itself.

In some embodiments of the present invention an establishment may define or otherwise maintain a supplementary playlist for periods of time when there are no currently playing or currently pending patron-selected media items. During such periods of times media items may be selected from the supplementary playlist of the establishment. The supplementary playlist for the establishment may be maintained upon the establishment media server. The establishment media server may automatically select songs from the supplementary playlist when there are no patron-selected media items pending for play. In alternate embodiments an automatic selection method may be employed for randomly or intelligently selecting media items from a pool of media items during periods of time when there are no currently playing or pending patron-selected media items. Such methods enable media to be seamlessly played during periods when patrons do not select media items. Advanced methods for automatic media selection are disclosed in patent applications by the present inventor and have been incorporated by reference herein, including above-referenced U.S. Provisional Application No. 60/809,951.

As mentioned previously, some embodiments of the present invention enable the user to download the media menu (i.e the listing of media items that are available for selection for play in the particular establishment) onto his or her portable computing device and may review the listing and interactively select an item from the list. In some embodiments the listing is updated regularly, excluding items that are currently pending upon a playlist for that establishment. In some embodiments the listing is also updated regularly to exclude items that have recently played within the establishment, for example have played within the last 2 hours. This prevents a user from selecting a media item that has already been selected by another patron and is currently pending play (or has recently played within the establishment). In a preferred embodiment the musical media item that are listed within the available media for an establishment, but which is not available for current selection because it is currently pending (or has recently played), appears on the list but is visually identified as not being selectable at the present time. The unselectable item within the list may appear grayed-out or may have another visual indicator that makes it clear to the user that it is not currently available for selection even though it is upon the full list of songs available that is normally available within the particular establishment. In this way a user may download from the establishment media server, onto the portable computing device of the user, a listing of the media items that are generally available for play within that particular establishment, updated to exclude those items that are currently pending for play within the establishment and thus not available for play and/or that have recently played and are thus not available for play within the establishment.

In some embodiments the listing of menu of items that are available for play within a particular establishment is configurable by an owner or operator of the establishment through a selection process engaged with the establishment media server. For example an owner or operator may identify a set of 500 songs that are available for selection by patrons of the establishment. This set of songs may be defined as a list downloaded to the establishment server from a computer of the establishment itself. This set of songs may be changed daily by the establishment to create variety in what is played within the establishment. This set of songs may also be updated regularly to include new music and remove old music. In this way the establishment media server enables a highly flexible definition of the set of songs that are available for selection by the patrons of the establishment. In addition the owners and/or operators may print the current set of songs in a menu format for placement on the tables of the establishment. In this way users may view the current menu of available media in a convenient form, the printed menu including a unique ID value associated with each media item as described previously.

In some embodiments of the present invention the patrons of an establishment may view the currently pending playlist for that establishment upon their wireless computing device. In some such embodiments the patron of an establishment may enter the unique ID code (and/or password) for the establishment into his or her portable computing device or receive the unique ID code (and/or password) automatically upon his or her portable computing device when within the establishment through for example WiFi, Bluetooth, or RFID communication links. In other embodiments the portable computing device may include a locative sensor such as a GPS sensor and the system may access the unique establishment ID for a particular establishment that the user is proximal to by accessing a lookup table that relates the establishment ID to a particular range of geospatial coordinates in the real physical world.

The portable computing device may then send the unique ID (and/or password) for the localized physical establishment to an establishment media server which in response sends the current playlist to the portable computing device of that user. The playlist may then be displayed upon a screen of that portable computing device, allowing the patron to see which songs, how many songs, and what order of songs, are currently pending for play within the localized physical establishment. The user may then review the listing as he or she decided if to add a song to playlist and/or what song to add. Thus the user may download from the establishment media server the current pending playlist as well as menu of available songs from which to select. In some embodiments the currently pending playlist may also be downloaded by a computer of the establishment and may be presented upon a screen of the establishment, for example a screen above the bar and/or at other convenient locations for viewers to view.

It should be noted that in a preferred embodiment a unique and inventive centralized establishment media server is provided that services a wide range of establishments across a geographic area. Thus a single establishment media server may, for example, service hundred or thousands or even more establishments around a geographic area. There is substantial business and feature benefits of this inventive centralized establishment media server that maintains playlists for a plurality of localized physical establishments as identified by their unique Establishment ID. One key benefit is the ability to sell a subscription service to users, the subscription service enabling the users to make media selections across a number of different establishments when they visit each establishment. For example a user could buy the right to make unlimited selections and/or a set number of monthly selection selections for all participating establishments based upon a subscription service. The establishment media server would operate this service by maintaining an account and related data for each subscriber user, the data being relationally associated with a unique ID for that user. In some embodiments the unique ID may be the phone number or other electronic address of the portable computing device used by that user. Thus the unique ID and account may be user specific or portable computing device specific. Either way, a user may buy an account by paying a fee and signing up for a subscription service. The user may then make media selections across a variety of establishments that are participants in the service. The user may enter any one of the establishments and make a selection for that establishment as described previously, by sending a message to the establishment media server 198 that indicates the particular establishment (by establishment ID) and by indicating the particular media selection (by unique media ID). The server then adds the particular selection to the playlist of the particular establishment. In this way a centralized establishment media server may maintain individual and separate the playlists for a plurality of localized physical establishments AND may track user accounts and user activity across establishments. For example data may be collected for a particular user by the establishment media server, the data documenting the number of selections made, the particular selections made, and/or the establishments for which the selections were made, across a range of physical establishments visited by a user over a period of time. This provides for powerful data tracking capabilities, useful account subscription and tracking capabilities, and valuable economies of scale for supporting the service. Thus the inventive centralized establishment server provides substantial business benefits. The centralized server model also enables the establishment server to track usage, song popularity, and genre popularity across establishment and/or across geographic locations associated with establishments.

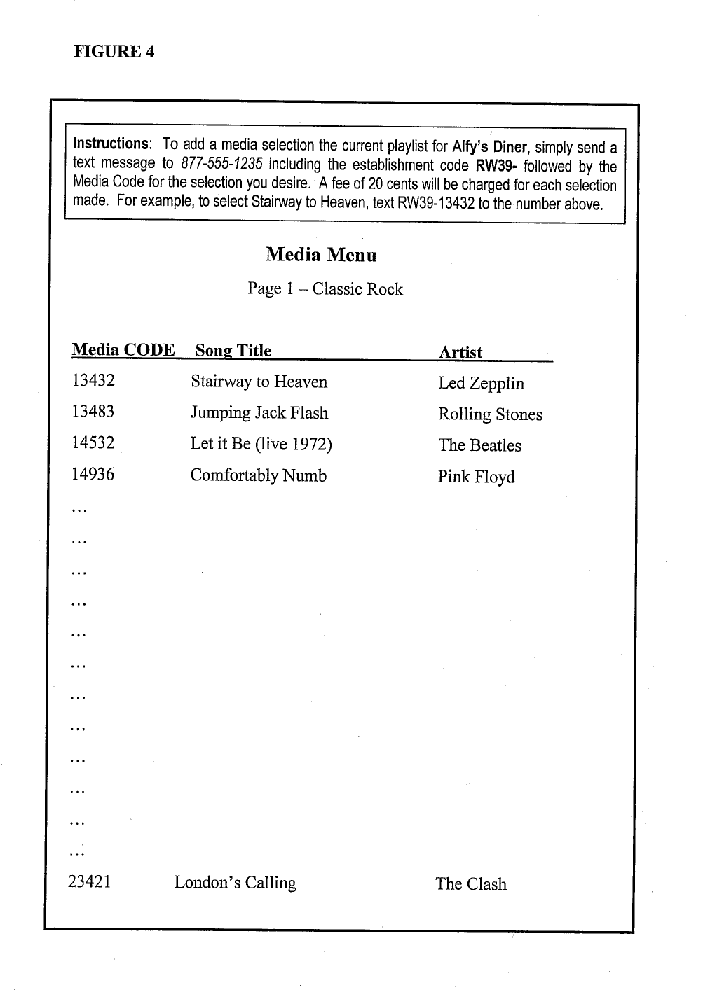

Referring next to FIG. 4, depicted is an example Media Menu as it might be printed on paper and placed upon the tables within an establishment such as a restaurant, bar, coffee house, club, or gym. In some instances such a paper media menu may be printed and stored in a bound binder such as traditional food menu or wine list. In other instances such a paper menu may be printed and placed under the glass surface of the table. In other instances such a paper menu may be posted upon a wall. In other instances such a paper menu may be printed upon a placemat. In a preferred embodiment the paper menu includes hundreds of songs across a variety of styles and/or genres and is printed on multiple pages that are stored in a bound binder or booklet. The media menu may be categorized by genre, for example including a section for each of classic rock, country music, oldies, current pop hits, hip-hop, and alternative. As shown in FIG. 4, a single page of such a multi-page media menu is depicted as it might be printed upon a paper document and distributed to patrons of an establishment, for example in binders upon their tables. The document includes an instruction section at the top that indicates to the user how they may use their own portable computing device to make a selection. These instructions include a messaging address, which could be an email address, instant messaging address, text messaging address, or other commonly accessible messaging address, that indicates how the user may send an electronic message to the establishment media server 199. In this particular instance it is a phone number to be used for text messaging. In this instance the phone number is listed as 877-555-1235. Thus the user is instructed that to send a media selection to the establishment media server 199, he or she should send a text message to the provided phone number.

In addition the instructions provide the user with an establishment ID code by which to identify the establishment. This ID code is listed as RW39 and is unique to the particular establishment for which this media menu is associated. In this instance the establishment is Alfy's Diner.

In addition the instructions inform the user how to send a proper message to the establishment server. In this instance the user is to send a text message to the provided phone number, the text messaging including the establishment ID code, followed by a dash, followed by the media code for the selection that is desired. Further down on the page of the media menu is a listing of media items, by title and artist, that are currently available for play within this particular establishment (i.e. Alfy's Diner). Each media item is also listed along with its unique media code. The unique media code may be a code that is used consistently by the establishment server 199 across all media menus of all establishments that participate in the service. In other embodiments each establishment assigns its own unique media codes for the media items that are available within that establishment. Thus if the user wished to send to select a particular song to be played at Alfy's Diner, the user would send a text message to 877-555-1235 that includes the establishment code for the diner followed by a dash followed by the media code. In the instance that the user wishes to select Stairway to Heaven by Led Zepplin for play within Alfy's Diner, as listed in the Media Menu, the user would text: RW39-13432 to the provided phone number.

Upon receiving the text message, the establishment media server 199 accesses the playlist for the particular establishment relationally associated with the code RW39, which in this case is Alfy's Diner, and adds to the playlist for that establishment the particular media selection relationally associated with the code 13432, which in this case is Stairway to Heaven by Led Zepplin. The user who sent the text message is then charged a fee, for example 20 cents, for making the selection. In some such embodiments, the fee is charged using a reverse billing sms process in which a receipt message is sent by the establishment media server to the portable computing device of the user causing the user to be charged a fee upon his or her normal telecommunication bill (i.e. phone bill and/or text messaging bill). In other embodiments the user buys credits in advance and is debited one credit upon making the selection. In such embodiments a customer account is maintained for each of a plurality of users in a form that is accessible the establishment media server, each customer account being indexed with respect to the unique User ID of the customer. Additional details on the maintenance of a plurality of customer accounts for a distributed music selection service is disclosed in co-pending U.S. patent application Ser. No. 11/697,732 filed Apr. 8, 2007 by the present inventor and which is hereby incorporated herein by reference in its entirety.

In general the selected media item is then added to the end of the currently pending playlist. In some instances it may be added to the end of the primary playlist (i.e. the playlist of songs suggested by patrons), but ahead of supplementary playlist items (i.e. the playlist of reserve songs that play when there are no pending patron-selected media items).

The updated playlist is then downloaded from the establishment media server 199 to the establishment media player 198 of the localized physical establishment associated with the playlist. In this way the media player 198 local to the establishment is updated with a playlist reflective of the selection made by a wireless communication device of a patron.

In some embodiments, one or more display screen may be positioned around the establishment to display the currently pending playlist to patrons, or a portion of the currently pending playlist. This enables patrons to see what songs are going to be played in the near future as they have been selected by patrons. A display screen may be, for example, a flat panel display connected to a computer processor that is in wired or wireless communication with the establishment media server 199 and/or with the establishment media player 198. The display screen may display, in their pending order, the titles and artists of the songs that are to be played in the immediate future. For embodiments where some songs have been selected by patrons and some songs have been selected by automatic or scripted means, the displayed playlist upon the screen may identify visually which songs were selected by patrons.

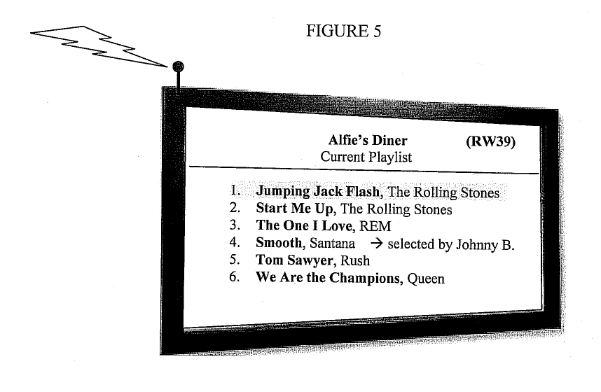

Referring next to FIG. 5, and example display screen is shown as it might display a playlist, or a portion of a playlist, that is maintained upon the establishment media server 199 and downloaded to the establishment media player 198. The display screen shown has an integrated processor that is in wireless communication with the internet and thereby receives data directly from the establishment media server. The integrated processor is encoded with the unique establishment ID of the localized physical establishment within which it is installed, for example RW39 of Alfy's Diner. Thus the processor queries the establishment media server for updated playlists using the unique establishment ID (in this instance RW39) and receives in return repeatedly updated playlists data. The data is displayed visually as shown in FIG. 5, indicating the pending order of media files by name and artist. In some embodiments the display also indicates a name of the user who selected it. In some embodiments the display simply indicates visually if the media item was patron selected or if it was automated selected by a scripted or automated process. The currently playing media item is highlighted as well, in this case the song Jumping Jack Flash by the Rolling Stones. In this way, patrons of the establishment may view the display screen and see the name and title of the currently playing song as well as the name and title of pending songs (and the order pending).

The display shown in FIG. 5 is a wall mounted flat panel display that is configured to be affixed to a wall, for example above or behind a bar in a restaurant, above the counter of a coffee house, on a prominent wall of a gym, or otherwise affixed in a visually prominent location.

In some embodiments of the present invention each user may configure his or her own portable computing device to receive playlist updates from the establishment media server for a current establishment. In such embodiments a display screen similar to that shown in FIG. 5 may be displayed directly upon the display of the portable computing device of patrons of the establishment. In some embodiments the user is alerted each time the playlist changes, for example by an audible beep from an audio output of the portable computing device. In this way a user may view his or her portable computing device and see regularly updates playlists reflecting the current and future songs to be played within a particular establishment. In a typical embodiment a user imply types in the establishment code for a particular establishment and then selects through a user interface of the portable computing device, an option that causes the portable computing device to receive repeatedly updated playlists for that establishment upon his or her portable computing device.

In such an embodiment an establishment media interaction application runs upon the portable computing device of the media player enabling it to repeatedly receive updated playlists from the establishment media server and display the playlist to the user upon a display of the portable computing device. The establishment media interaction application may be configured to uniquely highlight upon the playlist displayed upon a particular patrons portable computing device, those media items that were added to the playlist by that patron. Thus if a patron made three selections for pending media items that were added to a playlist that has been generated for a particular establishment, those three media items may be uniquely highlighted within the display of the playlist for the particular establishment upon the portable computing device of that user.

In some embodiments the displayed playlist, whether it is displayed upon a screen of the establishment as shown in FIG. 5 or whether it is displayed upon a screen of a portable computing device of a patron, may also include the time duration of each media item, in addition to its name and title. In this way a user may quickly scan the media items in the playlist and see the amount of time each will play for. In some embodiments the playlist displayed upon the screen of FIG. 5 may also include a unique ID for the user who made the selection. This unique ID may be a handle, user name, phone number, electronic address, or other unique identifier of the user who made the request. This way the patrons of an establishment may not only see what songs are pending, but also see an indication of which users made the request. In a preferred embodiment of the present invention, users may set up an account with the establishment media server and identify a unique handle or user name when setting up the account. This unique handle or user name is what is displayed upon the screen of FIG. 5 along with the requests made by that user. In this way a user may identify himself or herself using a name of his or her choosing, for example a nick name that does not reveal too much of his or her identity. In such embodiments the establishment media server maintains information for a user, relationally associating the electronic address of his or her portable computing device (for example the phone number) with the user's handle, user name, or other unique identifier.

Thus referring back to FIG. 5, we see that media item #4 in the list is the song “Smooth” as displayed upon the screen. Also displayed for this media item is the unique handle for the user who selected it. In this case it was a user who identified himself as “Johnny B” when establishing his account with the establishment media server service. Thus when he text messaged the establishment media server, the server was able to identify him by the unique ID of his phone number, access account information for that unique ID, and retrieve his unique handle “Johnny B.” This unique handle was then included in the playlist information displayed in FIG. 5, indicating not just the name of the song and the artist of the song and the order in which the song will play, but also indicating the handle of the user who made the selection. This feature can be a fun way for patrons to take credit for making a selection without revealing too much personal information about themselves (i.e. without revealing their unique phone number, just their casual handle).

It should be noted that in some embodiments the establishment itself may make selections for the playlist. In some such embodiments, selections made by the establishment itself may be identified upon the screen using a unique handle for the establishment. For example, the handle may be the name of the establishment. In this way patrons can easily see which selections were made by other patrons, and which selections were made by the establishment. In some embodiments selections may also be made by an automated process. In such embodiments the playlist may indicate “Auto” for the handle displayed along with selections made by an automated software process. In this way a patrons may easily see which playlist selections were made by other patrons, which were made by the establishment (i.e. were taken from a supplementary playlist for the establishment), and which were made by an automated process.

The present invention also provides for additional advanced interaction and messaging features in which a patron of a particular establishment may make unique requests with respect to a pending playlist for that establishment and/or may receive unique information relating to items within a pending playlist for that establishment. These advanced features are described as follows:

(a) In a first advanced feature of the present invention, a patron of a particular establishment is enabled pay a higher fee to cause his or her media selection to be skipped ahead of previously pending items on a playlist for that establishment. In such an embodiment the user may convey an “urgent” media selection with the understanding that it is charged a higher fee than an “ordinary” media selection. This distinction as to whether a media selection is “urgent” or “ordinary” is made through the user interface of the portable computing device of the requesting user. In some embodiments the distinction is identified in the coded message sent by the user to the establishment media server. For example, a coded symbol or combination of symbols may be used to indicate that a particular media selection is deemed urgent. In one such embodiment the coded message includes a unique symbol combination such as ## after a media code to indicate that that particular media selection is deemed urgent and should be treated (and billed) accordingly. Thus if a user text messaged the symbols “RW39-14532##” to the phone number (or other address) relationally associated with the establishment media server 199, the user indicates to the server a desire to have “Let it Be” by the Beatles played (because that song corresponds with the Media Codel4532 in this example) in the establishment Alfy's Diner (because that establishment corresponds with the Establishment code RW39 in this example) at an urgent priority level (as indicated by the ## symbol combination).

The media selection is then added to the playlist for Alfy's Diner and is placed ahead of any pending songs that are of “ordinary” priority level. Only other pending songs that were also deemed “urgent” (if any currently pending items on the playlist queue for Alfy's Diner were designated as such) are still listed ahead of the urgent media selection. The user is then charged for the urgent selection at a higher fee rate than the ordinary selection. In some such embodiments, the user is charged the urgent media selection fee using a reverse billing sms process in which a receipt message is sent to the user causing the user to be charged a fee upon his or her normal telecommunication bill (i.e. phone bill and/or text messaging bill). In other embodiments the user is charged on a credit account that is maintained on and/or maintained accessible to the establishment media server.

In an example embodiment, ordinary media selections are billed at 20 cents per selection while urgent media selections are billed at 70 cents per selection. In this way a user may selectively make a media selection at one of two levels of priority and pay accordingly for the requested priority level. Media selections are ordered on the playlist in the order they are received, with the exception that media selections with an urgent priority will be listed ahead of media selections of ordinary priority. Still media selections of urgent priority will be listed behind any previously selected and currently pending media selections of urgent priority. This creates an incentive for users to pay more for media selections that they want to ensure are heard sooner.

(b) In a second advanced feature of the present invention, a patron of a particular establishment is enabled to pay a selectively higher fee to prioritize his or her media selection to a range of priority levels. In one such embodiment a user may add a particular symbol, or combination of symbols, to indicate a level of priority that he or she is assigning to the media selection. For example, a symbol such as a “#” may be included after the media code of an media selection one or more times, the number of times it is included the amount of priority the user is assigning to the media selection. In one such embodiment, each “#” represents an additional level of priority and is billed an additional 10 cent increment. Thus a media selection with three “#” symbols following it is assigned level three priority and is billed the standard fee plus three times the priority fee. In a common embodiment this may be 20 cents plus three times a priority fee of 10 cents, or a total of 50 cents. In this way a user may selectively assign any level of priority to a media selection as a means of moving his or her selection higher upon the pending playlist that certain other of the currently pending items.

As an example of how this selectively priority media selection method may be implemented, the number of trailing “#” symbols after a media code indicates the number of additional priority units added by the user in his or her selection. Thus if a user sent the following text message to the establishment media server, “RW39-13432####”, he or she would be indicating that Stairway to Heaven (as indicated by the media code) be added to the playlist for Alfy's Diner (as indicated by the establishment code) with an additional priority level of 4 (as indicated by the four “#” symbols). The establishment media server upon receiving this request, adds Stairway to Heaven to the playlist associated with Alfy's Diner, moving it ahead of all currently pending media items that have a priority level lower than 4. In this way it will follow only those previously selected media items of the same or higher priority level in the pending playlist. This enables a user to place a media item selectively higher upon a pending playlist queue by paying a selectively higher fee. If a user desires to have his or her media selection play next (i.e. after the currently playing media item), he or she need only assign a higher level of priority to the media selection than is assigned to any currently pending media selection in the cue. This provides an incentive for users who want to hear their songs soon to assign higher and higher priority levels and thus pay higher and higher fees for their selections. This creates competition among patrons of an establishment and generates higher fees for the service provider and/or the establishment.

In some embodiments that enable a user to assign one or more different priority levels to a media selection, the assigned priority level may be indicated upon a displayed playlist so as to enable other patrons to view the priority levels of pending songs upon a playlist. In this way a user may determine how high of a priority level must be assigned to a media selection for it to be moved up to certain place within the pending playlist queue. This ability to display priority levels of a media selection helps to add to the competition among patrons and may help generate higher fees for the service provider and/or the establishment.

In some embodiments the establishment media server is configured to maintain a priority level associated with particular users, relationally associated with their unique user ID. A user may earn a higher priority level by signing up for a fee based subscription service, for example by paying a monthly fee. Such a user is relationally associated with a higher priority level in a user database that is accessible to or incorporated within the establishment media server 198. The establishment media server is then operative to assign that priority level to all media selections made by that particular user. In this way a user may, for example be deemed a Preferred Member of the service as a result of paying a particular service fee, and thereby have all of his or her media selections added to pending playlists for establishments at an order that jumps ahead of other selections made by users of lower priority level and/or selections relationally associated with lower priority levels.

In some embodiments the establishment media server is configured to award higher priority levels to users based upon the number of paid selections they make in a particular time period. In this way user's are rewarded for their usage of the service, the more selections they make over a particular time period, the higher the priority level they may earn. In one such embodiment users are categorized as being within one of multiple priority levels including a Basic Member, a Frequent Member, and a Power Member based upon the number of paid selections made by the user, across a variety of establishments, over a period of time. This rewards users for the number of selections made, not just within a single establishment, but across a plurality of establishments that are subscribers to the service. In one such embodiment a user who makes less than 50 selections of media for establishment playlists within a one-month period is deemed a Basic Member. His or her selections are associated with a level one priority. Users who more than 49 and less than 100 selections within a one-month period are deemed a Frequent Member. The selections made by such members are assigned a level two priority. Users who make more than 99 selections within a one-month period are deemed Power Members. Their selections are assigned a level three priority.

The system is enabled by software running upon the establishment media server, the software maintaining a database in which a selection tally is maintained for each user in relational association with their unique User ID. Thus every user of the system has a data stored for him or her in a database accessible to the establishment media server, the data stored indicating the number of paid media selections made by that user over particular time periods. The data within the database for each user also documents a priority level for that user, including for example an indication if the user is a Basic Member, Frequent Member, or Power Member. The software running upon the establishment media server thus performs database functions when receiving a media selection from a user of a particular user ID. In some embodiments the unique user ID is the phone number of the phone from which the user sends a text message. In other embodiments an alternate unique address of the portable computing device or user of the device is used as the unique ID for that user. The establishment media server thus uses the unique ID to document the number of selections made by the user. The establishment media server may also document the particular suggestions made (i.e. which songs, which artists, that times the suggestions were made, and/or what establishment the suggestions were made for). The server also determines and stores the priority level for the user. Additional details describing database architectures for documenting user media selections are described in numerous of the co-pending patent applications by the present inventor that have been incorporated by reference herein, including for example the customer database described in parent U.S. patent application Ser. No. 11/697,732.

When a user of a particular User ID sends a selection of a particular song (i.e. with a particular Media ID) for a playlist associated with a particular establishment (i.e. with a particular Establishment ID), the establishment media server accesses the database entry for that particular user, increments the tally count for the number of media selections for that user over a particular period of time, optionally documents the title, artists, and establishment of the selection in a history data store for that user, and accesses (and optionally updates) a stored priority level for that user. The establishment media server then adds the designated media selection to the current playlist for the designated establishment, the placement of the media selection being based at least in part upon the current priority level for the particular user. In a common embodiment the media selection is placed ahead of all currently pending media selections that are associated with a lower priority level. In this way a higher priority user is rewarded with the ability to have their selections played sooner than lower priority users. Because the business method described herein rewards users for greater activity (i.e. more paid selections over a period of time), users are incentivized to make frequent media selections and thereby earn a higher priority and thus the ability to have their media selections played sooner upon an establishment playlist.

Because each user is credited for media selections across any participating establishment that uses the service provided by the establishment media server, the inventive architecture of having a centralized establishment media server that services a large number of establishments over a geographic area provides many significant business advantages. One advantage is the ability to enable users to earn higher priority levels based upon music selections made for a variety of localized physical establishments. Another advantage is the ability to track a user's activity with respect to music selections across a variety of localized physical establishments. Another advantage is the ability to track a user's patronage across a plurality of localized physical establishments by date, time, and number of visits. Another advantage is the ability to provide establishment specific messages to the portable computing devices of users in response to indications of their patronage. Another advantage is the ability to enable users to pay a subscription fee for higher priority levels, their priority level being used for selections they make across a variety of localized physical establishments. In addition the centralized establishment media server architecture provides a significant economy of scale, enabling a single software infrastructure to support the patron selected playlist needs of a large number of establishments that are differentiated by a unique establishment ID. The centralized establishment media server architecture also provides an ability to process statistical data across a number of establishments, determining song popularity across regions based upon the geographic location of each participating localized physical establishment.

(c) In a third advanced feature of the present invention, a patron of a particular establishment is enabled to receive an electronic message from the establishment media server upon his or her portable computing device, the electronic message indicating the number of pending media selections on a playlist associated with a particular establishment. In one such embodiment the user may send a playlist size request to the establishment media server by sending a coded message from his or her portable computing device to the establishment media server, the coded message identifying a particular establishment (by unique ID) and identifying a desire to receive a playlist size. The establishment media server is configured to respond by sending an electronic message back the requesting portable computing device, the electronic message indicating the number of pending songs on the playlist for the identified establishment. In some embodiments the electronic message may include the actual playlist for the establishment, including the list of media selections in their designated order. Either way the information provided is displayed upon a screen of the portable computing device of the user, thereby enabling the user to review it locally upon his or her device. The user may then see, for example how many pending songs are upon the playlist and evaluate if the user wants to add a pending song to the playlist.

In one particular embodiment the user may send a text message that includes the characters “PL” for playlist followed by a dash followed by the establishment ID of the establishment for which the user desires to receive playlist information. Thus the user might send a text message to the establishment media server of “PL-RW39” as a coded message requesting the playlist count and/or the full playlist content for the establishment of ID RW39 (i.e. Alfy's Diner). The establishment media server receives this message and responds by accessing the playlist for the designated establishment and sending the information about the playlist to the portable computing device that made the request.

(d) In a fourth advanced feature of the present invention, a patron of a particular establishment is enabled to receive an electronic message from the establishment media server upon his or her portable computing device, the electronic message indicating the total time of pending media selections on a playlist associated with a particular establishment. In one such embodiment the user may send a playlist time request to the establishment media server by sending a coded message from his or her portable computing device to the establishment media server, the coded message identifying a particular establishment (by unique ID) and identifying a desire to receive a total playing time of the pending playlist for a particular establishment. The establishment media server is configured to respond by sending an electronic message back the requesting portable computing device, the electronic message indicating the total playing time of pending songs on the playlist for the identified establishment. The user may then evaluate if the user wants to add a pending song to the playlist.

In one particular embodiment the user may send a text message that includes the characters “PT” for playlist followed by a dash followed by the establishment ID of the establishment for which the user desires to receive playlist time information. Thus the user might send a text message to the establishment media server of “PT-RW39” as a coded message requesting the playlist time for the establishment of ID RW39 (i.e. Alfy's Diner). The establishment media server receives this message and responds by accessing the playlist for the designated establishment, determines the total play time based upon the playtime for each included song, and sends the playlist time information to the portable computing device that made the request.

(e) In a fifth advanced feature of the present invention, a patron of a particular establishment is enabled to send rating data to the establishment media server relating to a media item currently playing within an establishment, the establishment media server tallying the rating data from patrons and providing a statistical compilation back to patrons of the establishment. This enables patrons within a particular establishment to collectively rate a playing media selection and view the collective ratings. The rating data collected from each patron may be binary (i.e “like it” or “dislike it”) or may be a value upon a subjective rating scale (i.e. a value from 1 to 10 with 10 being the most favorable). The current rating tally may be sent from the establishment media server to a screen of the establishment, such as the screen shown in FIG. 5, and/or may be sent to the individual portable computing devices of patrons who have been identified as being located within the establishment. In one such embodiment, all users who send their own rating of a currently playing media selection is provided with a rating compilation statistic, either at the end of the song, or repeatedly updated during the playing of the song. In some embodiments an indication of the rating tally result is also sent to the portable computing device of the user who initial selected the media file for play within the particular establishment. The data sent to the users may include an indication, for example, the average rating value received from users and/or may receive a statistical value indicating the percentage of users who rated the playing media item favorably. In addition an indication of the total number of users who provided rating values may also be conveyed in the message. In this way users within an establishment may share a fun social experience wherein they collectively decide if a media selection was good or bad. This enables a user to make a selection for all the patrons of an establishment and then get feedback from the patrons when the media selection is played as to whether or not they liked it. This creates a fun social environment for patrons.

In one particular embodiment the patrons of an establishment may send a coded text message to the establishment media server indicating if they LIKE or DISLIKE the currently playing song within that establishment. The message may simply indicate the unique ID for the establishment and a code for LIKE or DISLIKE. In one such embodiment the electronic message includes the establishment ID, followed by a dash, followed by the code “LI” for love it, and “HI” for hate it. Thus a patron of a particular establishment with ID value TX84 may hear a currently playing song, like that song, and express their like to the media server by sending a text message to the server “TX84-LI”. The establishment media server receives this electronic message and tallies the vote for the currently playing song. Thus the establishment media server maintains an independent tally for the rating of the currently playing song within each of a plurality of establishments. For this particular establishment, the tally is maintained for the number of positive votes and the number of negative votes received from patrons of that establishment during the play of that particular song. At the completion of play of the song, the establishment media server sends a message back to all the patrons who cast votes, as well as the user who selected the song for play, indicating the final tally of rating data for that song within that establishment. Thus a tally is made for the currently playing song within establishment TX84 indicating that 78% of rating patrons within that establishment liked the long and 22% of rating patrons from that establishment disliked the song. The message may also provide an indication of the number of patrons who cast rating values, for example informing the patrons that 22 separate rating values were received from patrons. Thus each user who provided a rating is presented with a message upon their portable computing device indicating “78% Loved it”. In addition the user who made the selection for the playlist is also sent the message “78% loved it” thereby informing him or her of the favorability of his or her selection to the patrons of the establishment. The users may also be informed that “22 ratings were received.”

This ability to provide patrons who select music for play to an establishment with feedback as to the favorability of the selection to other patrons within the establishment is a unique and powerful feature that makes the experience more fun and interesting to users. For example a user may wonder if people like or dislike a particular song and thus may select it for play within an establishment. The user may then get feedback upon the completion of play of the media selection as to favorability of the section to the other patrons within the establishment. This is fun and also creates a social experience among patrons.

In some embodiments of the present invention the establishment media server keeps track of the user ID of each user who rates a currently playing song to ensure that a user may only provide a single rating for a particular play of a particular song within a particular establishment. In some embodiments the establishment media server is configured to only accept one rating value (for a particular song playing within a particular establishment) from each unique portable computing device, as identified by the unique electronic address of the portable computing device and/or the unique user ID of the user of that portable computing device. In some such embodiments, if a user provides more than one rating value for a particular song within a particular establishment, only one is used in the rating tally. In some such embodiments, only the first one received from that user is used in the rating tally. In other such embodiments, only the last one received from that user is used in the rating tally.

In some embodiments of the present invention the establishment media server also reports the number of unique rating messages received to the patrons who get a result message, the indication of the number of ratings giving patrons an idea of how many rating messages were cast in total and thus can better assess the validity of the result. It is also fun for patrons to know how many other patrons within an establishment listened to the song and made a determination as to favorability or dislike.

The establishment media server may also be operative to store data relating to patron ratings as a means for statistically determining song popularity. The establishment media server may combine rating data for particular media items across establishments and thus compute a diverse statistical indication of song popularity across geographic regions.

The establishment media server may charge users for sending rating messages, thereby enabling another business method for generating payments. A user, for example, may be charged 2 cents for casting a rating message, a relatively nominal fee but one that helps pay for the service provided by the establishment media server.

(f) In a sixth advanced feature of the present invention, a patron of a particular establishment is enabled to send a request to the establishment media server asking for descriptive information about a currently playing media item within the particular establishment, the establishment media server responding by sending information indicative of a title, artists, and/or date of the currently playing media item to the portable computing device of the requesting patron. The establishment media sever may also provide an indication of which patron selected the song for play, for example by user ID or unique user handle or unique user phone number. In this way a patron of a particular establishment may hear a song playing over the speaker and may wonder the title of the song, the artist, and/or the data of release. The user may satisfy this curiosity by simply sending a coded message of the establishment media server indicating the particular establishment that the user is in and indicating a desire to get descriptive information about the currently playing media file.

In one example the message sent may be the characters “INFO” followed by a dash followed by the unique ID of the establishment. Thus a user might text message “INFO-GX86” in order to receive info about the currently playing media selection within establishment GX86. The establishment media server may respond to the request by accessing the title, artist, and release data of the currently playing selection for establishment GX86 and send that information to the portable computing device of the requesting user. This information is then displayed upon a screen of the portable computing device of the user. The user may also be informed as to which patron selected the song. In some embodiments, the user is provided with a unique electronic address or ID of the user who selected the particular song for play within the particular establishment. The user may then use the unique address or ID to message that user, either directly or moderated through the establishment media server—for example, sending a text message to that user saying, “great choice!”

(g) In a seventh advanced feature of the present invention, a patron of a particular establishment is enabled may purchase a digital copy of a media file currently playing within an establishment by sending a purchase request to the establishment media server. This is a highly valuable feature because the song may start playing publicly within an establishment, for example a coffee house, and may remind a user during play that he or she loves that song. The user may then immediately react by sending a buy request to the establishment media server to purchase a digital copy of the song. The buy request may result in the portable computing device of the user downloading the contents of the media file from the establishment media server or from another server that is coordinated by the establishment media server. This feature turns physical establishments into a casual music store wherein users can buy any music that is heard playing over the speakers by simply sending a quick message from their portable computing device. The message may be a text message encoded with the word “BUY” followed by a dash followed by the unique ID of the establishment within which the desired song is currently playing. In some embodiments the user may be enabled to download the digital copy of the song to a separate computing device at a later time, by for example, logging into the establishment media server.

In this way a patron of a particular establishment may hear a song playing over the speaker and decide immediately to buy it. The user may satisfy this desire to purchase by simply sending a coded message of the establishment media server indicating the particular establishment that the user is in and indicating a desire to buy. In one example the message sent may be the characters “BUY” followed by a dash followed by the unique ID of the establishment. Thus a user might text message “BUY-GX86” in order to purchase the currently playing media selection within establishment GX86. The establishment media server may respond to the request by charging a fee to the user of the requesting portable computing device and then by sending a digital copy of the requested media file to that portable computing device. In some embodiments the establishment media server may act only as a broker, linking the portable computing device to a purchase process at an existing music sales site such as itunes.com. The establishment media server may then earn a commission for the service provider from the sales agent, for example from itune.com by Apple. In this way a service like iTunes is emboldened with location based establishments in which users listen to music casually and may device to purchase any song they hear within the establishment by sending a quick message from their portable computing device.

(h) In an eighth advanced feature of the present invention, a a particular establishment may receive monetary compensation for media files purchased by patrons of that establishment in response to the media file being played through the speaker of that establishment. Thus the establishment, identified by the Establishment ID, may be compensated with a monetary fee for each song purchased by patrons within their establishment (or using the establishment ID in their purchase request). Thus provides a business incentive for localized physical establishments to enable the inventive service within their grounds, for they turn their business into an informal music store in which they are compensated for music purchases made by their patrons. In some such embodiments the establishment media server maintains an account within a database for each participating establishment and credits the account each time a patron purchases a digital copy of downloadable song using the ID of that establishment. Similarly the account is credited each time a patron of that restaurant makes a media selection for a playlist. In this way the restaurant is compensated for fee-based media selections, fee-based digital media purchases, and optionally fee-based media ratings made by patrons of that establishment. This unique business model provides a strong incentive for establishments to enable the service within their location.

(i) In a ninth advanced feature of the present invention, a patron of a particular establishment is enabled to play a trivia game in which the patrons of an establishment may be awarded points for successfully indicating through their portable computing device their knowledge of the title, artists, and/or release date of a media file currently playing through the speakers of the establishment. In some such embodiments the patrons may compete against other patrons within the same establishment. In some such embodiments the competition is for total score across a plurality of played media items. In other embodiments the competition is a speed competition that determines which patron identifies the playing song first.

The process is enabled by a patron of an establishment indicating through a message sent to the establishment media server that he or she wishes to participate in a trivia game. The establishment media server then initializes a score variable for that patron and begins a process of streaming questions to that patron. The questions may include a multiple choice selection of the titles, artists, and/or release dates of a currently playing song. For example the question sent to the portable computing device of a participating patron may include the text “A) 1988 B) 1990 C) 1992 D) 1994”. The user understands that these are possible release years for the playing media selection. The user may then respond by sending a coded message back to the establishment media server indicating his or her answer. If the answer is correct, the score for the patron is incremented accordingly. In this way a user may listen to songs playing over the speakers of an establishment and play a trivia game moderated by the establishment media server, the server streaming questions, receiving answers, and awarding points accordingly. The server may maintain scores for a plurality of users within a particular establishment. The server may determine a winner and/or indicate to users through sent messages how their score compares to the current leader. An alternate text question may ask the user to identify the artists, for example “A) Beatles, B) Rolling Stones, C) Pink Floyd, D) Blue Oyster Cult”.

In some such embodiments a user is awarded points for being the first patron within an establishment to send the correct response to the establishment media server. In this way patrons within an establishment may compete in real-time to be the first responder to a question. The question may be streamed to patrons just before the song begins to play, thus causing patrons to listen to the song and identify it as quickly as they can so they can answer the question. The user enters their answer into the portable computing device, sends the message to the establishment media server. The server determines which patron was first to send the correct answer and deems that patron the winner, awarding points accordingly. In some embodiments the winner is awarded credits that may be used for making selections for the playlist. In this way patrons are encouraged to play the social trivia game for they have the possibility of winning free credits for use in making media selections within establishments.

In some embodiments the multiple choice methodology is replaced by a gaming paradigm where patrons are instructed to text the year of release as a text message to the establishment server as quickly as they can after a new song begins to play within an establishment. In this way a patron may simply text a message to the establishment server indicating the year of release of a currently playing song within a particular establishment, along with the establishment ID of that establishment, to participate in the game. The establishment media server moderates the game by determining which user was the first to text the correct year for a particular establishment. The server may moderate a plurality of such games simultaneously, each being conducted within a separate localized physical establishment.

(j) In a tenth advanced feature of the present invention, a patron of a particular establishment is enabled to request information from the establishment media server indicating the most popular song or songs within a particular establishment over a particular period of time. For example a user may wonder what song was selected for play the most often within a particular establishment over a particular period of time, for example over the last 90 days. The user may send a request to the establishment media server requesting such information. The establishment media server responds by sending an indication of the media item that was selected the most often within the particular establishment over the particular period of time. In some embodiments the particular period of time may be the current calendar year. In some embodiments the particular period of time may be since inception of the service within the establishment. Thus the user may request an indication of the most frequently selected songs within a particular establishment over the life of the service within the establishment. In some embodiments the server may indicate the most frequently selected song. In other embodiments the server may indicate a number of songs, for example the top five most frequently selected songs within an establishment.

The process may be enabled by the a patron of an establishment sending a coded message to the establishment media server from a portable computing device, the coded message indicating the particular establishment that the user is interested in and the coded message indicating that he wishes to see the most popular songs requested within that establishment. The coded message may include a particular sequence of symbols, such as “POP” for most popular, followed by a dash, followed by the unique code of the establishment. Thus the message “POP-RW39” would be a request to receive information about the most popular songs requested within establishment RW39 (i.e. alfy's diner). The establishment media server is enabled to process such requests because it is configured to store data indicating the number of times that each media item has been selected for play by patrons of that establishment. This data is stored in a database accessible to the establishment media server 198. The establishment media server thus reviews the data, finds the five media items that have been selected the most during a designated period of time (for example since inception of the service) within that particular establishment (i.e RW39). The media server then sends a message to the requesting portable computing device indicating, for example, the top five most selected songs within that establishment. This list is then presented upon the screen of the portable computing device of the patron who requested the information. The list may appear as follows upon the portable computing device of the requesting patron:

1) Stairway to Heaven

2) Sweet Emotion

3) Don't Fear the Reaper

4) Tom Sawyer

5) Start Me Up

In some embodiments the list may also indicate the total number of times the item was selected by patrons. In some embodiments the list may also be displayed upon a screen of the establishment, for example the screen of FIG. 5. In some embodiments the screen of FIG. 5 may be configured to regularly display the most frequently selected songs during a particular time period, for example during the current week. Thus every 15 minutes the screen may display the most popularly selected songs for the current week within the particular establishment. This data is interesting to patrons.

(k) In an eleventh advanced feature of the present invention, a patron of a particular establishment is enabled to dedicate a musical selection for an establishment to a particular other person. In one such embodiment the user may indicate that a media selection is dedicated to another person when making the selection and may indicate a unique ID for that other person. The establishment media server is then operative to send a message to that other person upon play of the selected media item, the message indicating that the playing media item has been dedicated to him or her. The message may also indicate the ID of the user who made the dedication. In some embodiments the unique ID of the user to whom the media selection was dedicated to may appear upon a screen of the establishment, for example the screen shown in FIG. 5.

In one example embodiment of a dedication feature of the present invention, a user may include within an electronic message to the establishment media server an indication that a media selection is to be dedicated as well as an indication of a unique user ID and/or unique user address for the dedicated party. In one example embodiment the unique ID of the dedicated party may be his or her phone number. Thus in such an embodiment the user may make a media selection and may indicate with a coded message, for example “Ded” to indicate a dedication, followed by a dash, followed by the phone number (or other ID or address) of the dedicated party. A user using such a system may for example request that Stairway to Heaven be played within Alfy's Diner and that it be dedicated to his or her friend whose phone number is 805-555-5512. This may be achieved by sending the following text message to the establishment media server:

“RW39-13432-DED-805-555-5512”

The text message thus includes the unique establishment ID (RW39) of Alfy's Diner, the unique media code (13432) of the song Stairway to Heaven, an indication that the song is to be dedicated (DED) and the phone number of the user to whom it is dedicated (805-555-5512). The establishment media server parses this message and takes appropriate action. It accesses the playlist for Alfy's Diner, adds the song Stairway to Heaven to the end of that playlist, and stores in memory a flag indicating that a user is to be notified of a dedication, the user being identified with phone number 805-555-5512. When the song stairway to heaven reaches the top of the playlist and begins to play, the establishment media server then sends a text message to the phone number 805-555-5512, the text message including a phrase such as “This song has been dedicated to you!” thereby informing the user that this song was dedicated to them. The message may also include an indication of who made the dedication. This indication may be provided by displaying the unique ID of the dedicating user to the dedicated user upon his or her portable computing device, the unique ID being a unique User Name, handle, phone number, or other electronic address. In this way a first user within an establishment may select a song for play to the entire establishment, but may privately dedicate the song to another patron of the establishment who automatically receives a message on his or her portable computing device informing him or her of the dedication when the song begins to play over the speakers of the establishment.

In many embodiments that support the dedication feature, the user who makes the dedication is charged an extra fee for the dedication process being implemented. In one such embodiment the user is charged 20 cents for the media selection and an additional 80 cents for the personalized dedication of the selection to another patron. This enables another business model by which the service provide can generate revenue. This revenue may be shared by the establishment itself, providing another incentive for the establishment to enable the feature.

In some embodiments, a first user who dedicates a particular music selection to a second user may include a personalized text message within the dedication request sent to the establishment media server, the personalized text message being delivered to the second user by the establishment media server in close time proximity to when the particular music selection begins to play within the particular establishment. In this way a first user may compose and send a personalized dedication message to the second user that is delivered to the portable computing device of the second user in close time proximity with the public play of the musical selection within the particular establishment. The personalized text message may be, for example, a short text string such as “Thinking of you . . . ”

In some embodiments the dedication message, whether standard or personalized, is displayed upon a screen of the establishment, for example the screen of FIG. 5. The dedication message upon the screen may include a unique ID (name, handle, phone number, electronic address) of the dedicating party as well as the unique ID (name, handle, phone number, electronic address) of the party being dedicated. Thus it may say “Johnny B dedicates this song to Amy R”, thereby conveying the dedication to the patrons of the establishment. As described previously, a user of the present invention may set up an account upon the establishment media server, the account relationally associating a handle or user name with the unique ID of that user. Thus the user's unique ID may be his or her phone number or other electronic address, but the establishment media server may also maintain within a database a handle for that user—for example “Johnny B”. This handle need not be unique among all users, but simply be an identifier for the user. An additional unique ID, such as a phone number is relationally associated with the handle. The handle may thus be used in the dedication process if the user does not want to disclose his unique ID publicly (for example his phone number).

In certain situations, a first user may wish to dedicate a particular media file for play within a particular establishment to a second user who is not currently present within the particular establishment. To help avoid the situation wherein the song that has been dedicated to the second user is played within the particular establishment at a time when the second user is not currently present, some embodiments may be configured to enable a Time-Delayed Dedication Feature in which the dedicated media selection is stored in memory accessible to the establishment server but not added to the playlist for the particular establishment until a future time when the second user is determined and/or presumed to be present within the particular establishment. The establishment server may be configured to determine and/or presume that a particular user is present within a particular establishment in response to receiving an electronic message from a portable computing device of the user indicating his or her presence within the establishment. In some such embodiments the electronic message is an sms text message from the portable computing device of the user, the sms text messaging including the Establishment ID of the particular establishment.

Thus in such an embodiment, a first user may send a dedicated media request to the establishment media server indicating that a particular song (identified by unique media ID) be played within a particular establishment (indicated by unique establishment ID) and that that song be dedicated to a second user (indicated by the unique phone number or other unique ID of the second user) the next time that user is determined and/or presumed to be present within the particular establishment. The media request message is parsed by the establishment server and the media request is held in memory in a format relationally associated with the unique establishment ID of the particular establishment. Then at a future time when the second user is known and/or determined to be within the particular establishment (for example the second user sends a message to the establishment server indicating that he or she is present within the particular establishment, the message including the unique establishment ID of the establishment), the establishment media server automatically adds the dedicated media request to the pending playlist for the particular establishment. In this way the dedicated media request was “time-delayed”, by being held in memory until the next time when the second user was known to be within the particular establishment, and then added to the playlist. Thus upon determining and/or presuming that the second user is present within the particular establishment, the establishment media server adds the dedicated media file to the pending playlist for that establishment.

When that media file reaches the top of the playlist, it is caused to play within the particular establishment. At a time that is in close time proximity to the play of the media file within the particular establishment, the establishment media server sends a dedication message to the portable media player of the second user, indicating to that user that the playing song was dedicated to him or her. The dedication message may include an indication of who dedicated the song (i.e. an indication of the unique ID and/or other identifier of the first user) as well as an indication of when the dedication was left by the first user.

In this way a fun social process may be enabled wherein a first user may leave a dedicated song for a second user within a particular establishment, the dedicated song being played the next future time when the second user is known or presumed to be present within the particular establishment. This creates a fun surprise for the second user upon arriving at the particular establishment.

In some such embodiments the first user is sent a delivery message informing the first user that the dedicated music selection was played and dedicated to the second user. In this way the first user is informed that the second user did arrive at the particular establishment at some time in the future and did receive the dedicated song. This creates a fun mode of confirmation for the first user, informing the first user that the dedication process was completed as well as when the dedication process was completed.

In some such embodiments the first user is charged a fee for making the dedicated music request upon making the request. In other embodiments the first user is charged a fee for making the dedicated music request upon the play of the dedicated song within the particular establishment. In this way the first user is not charged unless the second user actually arrives (or is presumed to arrive) within the particular establishment and the dedicated media file actually plays using the dedication methods described above. In some such embodiments, the first user is charged the fee for the dedicated music selection using a reverse billing sms process in which a receipt message is sent to the first user causing the user to be charged a fee upon his or her normal telecommunication bill (i.e. phone bill and/or text messaging bill).

In some such embodiments a dedicated message may be associated with an expiration duration and/or expiration date such that if the dedicated message is not delivered within the expiration duration and/or by the expiration date, it is terminated. In some such embodiments the dedicating user may specify the expiration duration and/or expiration date.

In this way, for example a first user may leave a time-delayed dedicated music selection for a second user within a particular establishment and may define an expiration duration of 30 days. If the second user arrives within the particular establishment and/or is presumed to be present within the particular establishment during the 30 day period, the establishment media server will add the dedicated song to the pending playlist for that establishment and the dedication process is consummated. If on the other hand, the second user does not arrive within the particular establishment and/or is not presumed to be present within the particular establishment during the 30 day period, the time delayed dedication expires. It is thus deleted from memory by the establishment media server and is never consummated. In some such embodiments the first user may be sent an expiration message by the establishment media server, for example as an SMS text message, indicating that the dedication expired before it was ever delivered to the second user. In some such embodiments the first user is not charged for an expired time-delayed dedication.

In a related embodiment, a first user may dedicate a song to a second user and may indicate a listing of particular establishments and/or a range of particular establishment. The dedicated song will then be played within the first of the listing of particular establishments and/or range of particular establishments for which the second user is known and/or presumed to be present. In this way the time-delayed dedication process described above may be followed, but with the additionally novel process such that the second user may arrive in any one of a plurality of establishments and have the dedicated music selection consummated. This crates a fun music dedication process in which a first user may dedicate a song to a second user, specific for example, to a range of 1000 establishments, and have the establishment media player play the dedicated music selection to the second user the next time it is known and/or presumed that the second user is within any one of the 1000 establishments. In one such embodiment the range of 1000 establishments may comprise a particular chain of establishments, for example starbucks coffeehouses. Thus the establishment media player may be configured to play the dedicated music selection made by the first user, to the second user, the next time it is known or presumed that the second user is present within any one of a large plurality of starbucks coffeehouses.

Thus in one example scenario of the time-delayed dedication feature, a first user may dedicate a song to a second user, associate the dedication with 1000 startbucks coffeehouse establishments, and include a personalized text message such as “thinking of you.” The establishment media player will hold the time-delayed dedication in memory until the next time it receives an electronic message indicating that the second user, identified by unique user ID, is present within any one of the 1000 target establishments, identified by unique establishment ID. Upon receiving such a message, the establishment media server adds the dedicated song to the playlist queue of the particular starbucks coffeehouse for which the second user is known and/or presumed to be in, and waits for it to play in accordance with it reaching the top of the playlist. When it begins to play within the establishment, a text message is sent by the establishment media server to the portable computing device of the second user, including the personalized message “thinking of you” as well as an indication who left the dedication (by name and/or unique ID) as well as an indication of when the dedication was left. In addition the establishment media server sends a text message to the first user, indicating that the dedication was delivered, when it was delivered, and where it was delivered. This creates a fun and totally new form of establishment-based communication between the first and second users.

(l) In a twelfth advanced feature, a media request withdrawal process is enabled in which a patron may request that a pending media selection which was previously sent in by that patron, but not yet played within the target establishment, be withdrawn from the pending queue. In other words, the patron may take back a pending request that has not yet played by sending a withdrawal message to the establishment media server. In some such embodiments the withdrawing patrons receives a credit for a future media selection in exchange for the withdrawn media selection being removed from the pending queue of the identified establishment. In some such embodiments, the withdrawal message may be sent as an sms text message to the establishment media server indicating the establishment ID of the target establishment, a unique identifier of the media selection that is desired to be withdrawn, as well as an indication of the unique customer ID. In some such embodiments, the establishment media server will ONLY process a withdrawal request for a particular media selection pending for play within a particular establishment if it originates from a portable computing device that IS THE SAME as the portable computing device from which the media selection for that particular media file was originally made. In this way only the customer who makes a particular media file selection for a particular establishment may withdraw it from the playlist prior to play. In other embodiments a password process is used to confirm that the user has authority to withdraw a particular media file selection pending for play within a particular establishment.

In one embodiment the code “WD” is used to indicate a withdrawal message. Thus an sms message of the form RW39-WD-13432 may be sent to the establishment media server by a mobile phone of a user. The message is parsed by the establishment media server to indicate that song (Media ID=13432) is desired to be withdrawn (CODE=WD) from the playlist for establishment (Establishment ID=RW39). In addition the establishment media server may check the electronic address of the mobile phone from which the message was sent and confirm it is the same electronic address from which the original request for 13432 came that added it to the playlist in the first place. In this way only the same mobile phone may be used to withdraw the media selection as was used to originally make the media selection. In some such embodiments the user of the mobile phone is awarded a free credit for a future media selection in exchange for the withdrawal, thus giving the user the ability to select a new song with no additional charge. In some embodiments a nominal withdrawal fee is also charged to the user.

(m) In a thirteenth advanced feature, a media termination process in which a playing media file may be ceased from playing prior to full completion based at least in part upon a tally of rating data relating to that song, received from patrons while the song is playing, being determined to be below a certain threshold value level.

As described previously, some embodiments of the present invention are configured to enable a plurality of patrons of an establishment to use portable computing devices on their persons, for example their mobile phones, to send subjective rating information about a currently playing song within a particular establishment to the establishment media server, the establishment media server tallying the rating data from patrons and compiling a statistical resultant. In some embodiments if the statistical resultant is less than some threshold level, the playing media selection may be terminated from playing prior to full completion and the next media file in the playlist may be played quickly thereafter. In this way, if a collaborative pool of patrons indicate poor subjective preference for a currently playing media file, it may be ceased from play prior to completion and a next song may be played. The threshold level may involve a plurality of factors, for example including that (a) a minimum number of patrons send rating messages relating to the currently playing song, and (b) that the compiled resultant value of the rating data received in the rating messages meets a certain threshold requirement.

For example, if the rating data was in the form of a subjective rating value from 0 to 10, with 10 being the most favorable rating and 0 being the least favorable rating, the compilation resultant of the data may be a statistical mean of the rating values received. The threshold may be configured such that if the mean is less than a 2.0 (i.e. indicating very lower partiality towards the playing song across the rating users), the media file is terminated prior to full completion. In addition, the minimum number of patrons may be set to a value such as 5, thereby requiring that five separate users send rating messages from their portable computing devices with respect to the currently playing song within the particular establishment.

Thus the establishment media server will receive subjective rating values from patrons and compile a statistical mean across the values received. If in this example scenario, a minimum number of 5 rating messages were received AND if the mean rating value across the received messages is below the threshold value of 2.0, the establishment media server may be configured to cause the termination of the currently playing media file within the particular establishment prior to its full completion. The establishment media server may then cause the next media file in the playlist queue for that establishment to play. Because the rating data may take a variety of forms, the threshold meeting requirement for the rating data may take a variety of forms. In general the threshold is set such that the collective partiality towards the currently playing media is determined to be substantially low.

In some embodiments in which a media file playing within an establishment is terminated prior to full completion as a result of rating data being received from a plurality of users that is below a certain threshold level of partiality, the establishment media server is also operative to send a message to the requesting user indicating to that user that their media selection has been terminated. In some such embodiments the message sent to the requesting user includes an indication of the rating score received form the plurality of users. In this way a user who selects a particular media file for play within a particular establishment which is terminated for play prior to full completion as a result of low rating data received from other patrons, is informed that his or her selection has been terminated, why it has been terminated, what the compiled resultant rating value was, and/or how many users provided rating data that contributed to the collaborative termination.

(n) In a fourteenth advanced feature of the present invention, a patron of a particular establishment is enabled to make multiple selections in a single text message by stringing together a series of media codes, following a single establishment code. In one such embodiment a message includes an establishment code followed by a dash followed by a media code. This is then followed by a dash and another media code for each additional media selection the user desires. Thus if a user who is a patron of Alfy's Diner desired to make three selections including Stairway to Heaven, Jumping Jack Flash, and Comfortably Numb, he or she could send the a text message of “RW39-13432-13483-14936” to the phone number associated with the establishment media server 199 and thereby convey through a single text message a desire to add three media selections to the playlist. In one such embodiment, the order in which the media items are listed in the text message sequence is the order in which they are added to the playlist of the target establishment. The user who sent such a message would be charged for three media selections, for example 20 cents each for a total of 60 cents in billing. In some such embodiments the user could add ## to the end of any media code to make that media selection urgent. The user would then charged accordingly for the urgent selection, for example $1.00 for making the selection urgent as described previously.

(o) In a fifteenth advanced feature of the present invention, the establishment media server is configured to enable to allow a patron of a particular localized physical establishment to make a free media selection for play within that particular establishment in exchange for receiving an establishment-specific promotional message. The establishment-specific promotional message is sent from the establishment media server to the portable computing device of that patron, the establishment-specific promotional message providing information content about a product or service of the particular establishment. In this way a patron is provided with a free music selection within the particular establishment in exchange for receiving a promotional message relating to the establishment. In some embodiments the promotional message is sent immediately following the user's media selection. In other embodiments the promotional message is sent at a later date, for example days or weeks following the user's music selection within the particular establishment. In this way an establishment may be enabled to provide free music selections to patrons of the establishment in exchange for providing targeted promotional messages back to those patrons at a later date.

(p) In a sixteenth advanced feature of the present invention, a messaging convenience may be enabled wherein the establishment media server remembers the current particular establishment that a patron is patronizing for a certain period of time after receiving an establishment ID of that particular establishment from a portable computing device of the user. Referred to herein as patronage tracking embodiments, the establishment media server is configured to document in memory, over a period of time, an indication for each of a plurality of patrons, their current presumed presence within a particular localized physical establishment, For example, a user may send the coded message “GX86” to the establishment server from his or her portable computing device, indicating that he or she is currently patronizing that establishment. The establishment media server then stores in memory an indication that the particular user, referenced by his or her unique User ID, is currently patronizing the particular establishment, referenced by its unique Establishment ID. Then if the particular user sends additional messages to the establishment media server requesting establishment-related services and/or messages, the establishment media server may presume that the user is currently present within the particular establishment if he or she does not specify a particular establishment in the subsequent messages. This relieves the user of sending the unique ID for that establishment within each and every subsequent message to the server.

In some such embodiments the establishment media server is configured to document a user as being within the particular establishment that corresponds with the last Establishment ID that was received by the server from that user. In this way, the establishment media server stores data in memory relating to the last Establishment ID received from that user and presumes the user remains present within that establishment until a new Establishment ID is received from that user.

In some such embodiments the establishment media server is also configured with a time-out period, documenting the user as no longer within an establishment if a particular period of time passes since a message was received from that user indicating the particular Establishment ID. In some such embodiments the particular period of time may be set at 60 minutes. Thus if a user sends a message to the establishment media server with a particular Establishment ID value, the server is configured to document in memory that user is present within that particular establishment until either (a) the time-out period passes without an establishment ID value being received from that user, or (b) until a different establishment ID is received from that user indicating that the user is current present within a different establishment.

The patronage tracking methods, as described in the paragraphs above, provides a convenience for users, freeing them from needing to send the Establishment ID with every message sent to the establishment server. Instead the user need only inform the server each time he or she arrives in a new establishment and/or each time the user stays within an establishment for longer than the defined time-out period. This makes it easier to request establishment-related services, for once the establishment server is informed which establishment the patron is currently patronizing through an initial message containing the Establishment ID, subsequent messages may be conveyed without needing to resend the Establishment ID each time.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks. While the invention herein disclosed has been described by means of specific embodiments, examples and applications thereof, numerous modifications and variations could be made thereto by those skilled in the art without departing from the scope of the invention set forth in the claims.

What is claimed is:

1. A distributed media selection system for patrons of localized physical establishments comprising:
an establishment media server coupled to a network, the establishment media server comprising:
a processor; and
a computer readable storage medium coupled to the processor, the computer readable storage medium comprising:
a first database component having retrievably stored therein a plurality of unique media playlist queues, each of the plurality of unique media playlist queues associated with at least one of a plurality of localized physical establishments, each of the plurality of localized physical establishments having a unique establishment identifier associated therewith, each of the plurality of unique media playlist queues comprising an ordered listing of media files selected for play within a localized physical establishment associated with a respective one of the plurality of unique media playlist queues, and
a second database component having retrievably stored therein a plurality of unique media menus, each of the plurality of unique media menus associated with at least one of the plurality of localized physical establishments, each of the plurality of unique media menus comprising a listing of media files available for selection within a localized physical establishment associated with a respective one of the plurality of unique media menus, each of the media files available for selection and the media files selected for play having a unique media identifier associated therewith;
wherein the processor is adapted to:
receive over the network a plurality of media requests, each of the plurality of media requests originating from a separate personal portable computing device, each of the plurality of media requests including a media identifier, an establishment identifier, and a patron identifier,
update, for one or more of the media requests received, a media playlist queue by adding an indication of a media file associated with the media identifier received to the ordered listing of media files selected for play within a localized physical establishment associated with the establishment identifier received, and
cause, for one or more of the unique media playlist queues, the contents of a media file referenced on the media playlist queue to be publicly played by a media player within a localized physical establishment associated with the media playlist queue.

2. The distributed media selection system of claim 1 wherein a plurality of media files listed within each of the plurality of unique media playlist queues are caused to be publicly played in sequential order in accordance with the ordered listing of media files selected for play within the associated localized physical establishment.

3. The distributed media selection system of claim 1 wherein the computer readable storage medium further comprises a third database component having retrievably stored therein a plurality of customer accounts, each of the customer accounts having a unique customer identifier associated therewith.

4. The distributed media selection system of claim 3 wherein the unique customer identifier includes an electronic address of a portable computing device of a customer.

5. The distributed media selection system of claim 4 wherein the portable computing device is a telephone device and wherein the unique customer identifier includes a telephone number of the portable computing device.

6. The distributed media selection system of claim 3 wherein the plurality of customer accounts maintain information selected from the group consisting of a quantity of media selections made, the particular media selections made, and the establishments for which the media selections were made.

7. The distributed media selection system of claim 3 wherein each of the plurality of customer accounts includes a running total of fees charged for media selections.

8. The distributed media selection system of claim 1 wherein a media request may be associated with a priority level the priority level being used by the establishment media server, at least in part, in determining where the media file selected will be placed within the media playlist queue relative to other media files in the media playlist queue.

9. The distributed media selection system of claim 8 wherein a media file having a priority higher than a previously received media file is placed higher in a media playlist queue than the previously received media file.

10. The distributed media selection system of claim 8 wherein a fee is charged for the media request, the size of the fee being dependent at least in part upon the priority level.

11. The distributed media selection system of claim 1 wherein a customer account may be associated with a plurality of different priority levels, the priority levels being used by the establishment media server, at least in part, in determining the placement of a media selection received from the customer within the media playlist queue in relation to previously received media selections stored within the media playlist queue from other customers.

12. The distributed media system of claim 1 wherein at least one media request received from the personal portable computing devices is comprised of an SMS text message.

13. The distributed media system of claim 12 wherein the media identifier and the establishment identifier are encoded within the SMS text message.

14. The distributed media selection system of claim 1 wherein the processor is adapted to send to a particular portable computing device an informational message including an indication of the number of media files pending for play within a particular establishment.

15. The distributed media selection system of claim 14 wherein the informational message is comprised of an SMS text message.

16. The distributed media selection system of claim 14 wherein the informational message is sent in response to an informational request received from the particular portable computing device.

17. The distributed media selection system of claim 16 wherein the informational request includes the establishment identifier of the particular establishment.

18. The distributed media selection system of claim 1 wherein the processor is adapted to send an informational message to a particular personal portable computing device, the informational message including information about the currently publicly playing media file within a particular establishment, the information selected from the group comprising a title, an artist and a release date.

19. The distributed media selection system of claim 18 wherein the informational message is comprised of an SMS text message.

20. The distributed media selection system of claim 18 wherein the informational message is sent in response to an informational request received from the particular personal portable computing device.

21. The distributed media selection system of claim 20 wherein the informational request includes the establishment identifier of the particular establishment.

22. The distributed media selection system of claim 1 wherein the processor is adapted to send an informational message to a particular personal portable computing device, the informational message including an indication of an approximate total playing time of media files pending for play within a particular establishment, the informational message is sent in response to an informational request received from the particular personal portable computing device, the informational request including the establishment identifier of the particular establishment.

23. The distributed media selection system of claim 1 wherein the processor is adapted to receive a rating message from each of a plurality of portable computing devices, each rating message including rating data, the rating data providing an indication of customer partiality towards a currently playing media file within a particular localized physical establishment, the particular localized physical establishment identified by an establishment identifier included within each rating message.

24. The distributed media selection system of claim 23 wherein the processor is further adapted to compile the rating data received within a plurality of separate rating messages into a rating result.

25. The distributed media selection system of claim 24 wherein the processor is further adapted to cause a result message to be sent to at least one portable computing device, the result message including a representation of the compiled rating data.

26. The distributed media selection system of claim 25 wherein the result message is conveyed as an SMS text message.

27. The distributed media selection system of claim 24 wherein the processor is further adapted to cause a currently playing media file to cease from playing prior to full completion in response to a representation of the rating result being below a threshold value.

28. The distributed media selection system of claim 23 wherein the rating data received from each portable computing device comprises a numerical partiality indication within numerical a rating scale.

29. The distributed media selection system of claim 1 wherein the processor is further adapted to receive a purchase request from a particular portable computing device, the purchase request including an indication that a user of the particular portable computing device desires to purchase a digital copy of the content of a currently playing media file within a particular localized physical establishment, the particular localized physical establishment identified by a particular establishment identifier associated with the purchase request.

30. The distributed media selection system of claim 29 wherein the processor facilitates a transaction, the transaction including charging a fee to a customer associated with the particular portable computing device and causing a digital copy of the currently playing media file to be downloaded to the particular portable computing device.

31. The distributed media selection system of claim 30 wherein the processor is further adapted to credit a portion of the charged fee to an account associated with the particular localized physical establishment.

32. The distributed media selection system of claim 1 wherein the processor is further adapted to cause a fee to be charged to each of a plurality of customers, each charged customer being associated with one of the plurality of personal portable computing devices from which separate media requests are received.

33. The distributed media selection system of claim 32 wherein the fee is charged using a reverse billing method in which the fee is added to each of the plurality of customers phone bill.

34. The distributed media selection system of claim 32 wherein the processor is further adapted to credit a portion of each charged fee to an account associated with the localized physical establishment for which the media request was made.

35. The distributed media selection system of claim 1 wherein at least one media request is a dedicated media request, a dedicated media request including an indication of at least one third party customer to whom a media selection is dedicated.

36. The distributed media selection system of claim 35 wherein the indication of the at least one third party customer is conveyed is information chosen from the group consisting of a phone number, electronic address, and user name, of the at least one third party customer.

37. The distributed media selection system of claim 35 wherein the processor is further adapted to cause a textual message to be displayed upon a personal portable computing device of the at least one third party customer at the approximate time when the dedicated media selection plays.

38. The distributed media selection system of claim 37 wherein the causing of a textual message to be displayed is accomplished, at least in part, by an automatic conveyance of an sms text message to a personal portable computing device of the at least one third party customer.

39. The distributed media selection system of claim 37 wherein the textual message includes a textual indication of information chosen from the group consisting of a name, a handle, an electronic address, a phone number, and a unique identifier of the customer who submitted the dedicated media request.

40. The distributed media selection system of claim 1 wherein the logical instructions are further operative to compile a mathematical indication of media file popularity within a particular localized physical establishment based upon at least one of the number times the media file is selected for public play within the particular localized physical establishment and the rating data received in response to the public play of the media file within the particular localized physical establishment.

41. The distributed media selection system of claim 40 wherein the processor is further adapted to report a representation of the popularity of at least one media file at the localized physical establishment, to each of a plurality of the separate personal portable computing devices.

42. A method of distributed media selection for localized physical establishments comprising:
receiving a media request over a network from a personal portable computing device, the media request comprising a media identifier, an establishment identifier and a customer identifier;
updating a media playlist queue associated with the establishment identifier, the updating comprising adding a media file associated with the media identifier to a listing of media files pending for play within a localized physical establishment associated with the establishment identifier; and
causing the output of the contents of the media file as music at the localized physical establishment.

43. The method of distributed media selection of claim 42 further comprising maintaining a database of a plurality of customer accounts, each of the customer accounts having a unique customer identifier associated therewith.

44. The method of distributed media selection of claim 43 wherein the unique customer identifier includes information selected from the group consisting of a phone number and a unique electronic address of the portable computing device associated with the customer account.

45. The method of distributed media selection of claim 43 wherein the personal portable computing devices is a telephone device.

46. The method of distributed media selection of claim 43 wherein each customer account includes a record of information chosen from the group consisting of a quantity of media selections made, a particular media selections made, and a localized physical establishment for which the media selections were made.

47. The method of distributed media selection of claim 42 wherein the media request is associated with a priority level, the priority level being used, at least in part, in determining where a media selection included within the media request will be placed within the media playlist queue as compared to previously received media selections stored within the media playlist queue.

48. The method of distributed media selection of claim 47 wherein the media selection included in the media request that is associated with a higher priority level, is placed higher in the media playlist queue than previously received media selections stored in the media playlist queue with lower priority levels.

49. The method of distributed media selection of claim 48 a fee is charged for the media request associated with the increasing the priority level.

50. The method of distributed media selection of claim 42 wherein the media request received from the personal portable computing devices is comprised of an SMS text message.

51. The method of distributed media selection of claim 50 wherein the media identifier and the establishment identifier are encoded within the text message.

52. The method of distributed media selection of claim 42 further comprising causing an informational message to be sent to the personal portable computing device, the informational message including an indication of the number of media files pending for play within the media playlist queue.

53. The method of distributed media selection of claim 52 wherein the informational message is comprised of an SMS text message.

54. The method of distributed media selection of claim 42 further comprising causing an informational message to be sent to the personal portable computing device, the informational message including an indication of information selected from the group comprising a title, an artist, and a release date, of the media file currently publicly playing within the particular localized physical establishment.

55. The method of distributed media selection of claim 42 further comprising causing an informational message to be sent to the personal portable computing device, the informational message including an indication of the approximate total playing time of a plurality of media files currently pending for play within the media playlist queue.

56. The method of distributed media selection of claim 42 further comprising receiving rating data from the personal portable computing device, the rating data including an indication of customer partiality towards a currently playing media file within the localized physical establishment, the localized physical establishment identified by the establishment identifier associated with the rating data.

57. The method of distributed media selection system of claim 56 further comprising compiling the rating data with additional rating data received from each of a plurality of other portable computing devices and producing a resultant representation of the compiled rating data.

58. The method distributed media selection of claim 57 further operative to cause a result message to be sent to the portable computing device, the result message including an indication of the resultant representation of the rating data.

59. The method distributed media selection system of claim 57 further comprising causing a currently playing media file within the localized physical establishment to cease from playing prior to full completion in response to the resultant representation of the compiled rating data being below a threshold value.

60. The method of distributed media selection of claim 42 further comprising receiving a purchase request from the portable computing device, the purchase request including an indication that a user of the portable computing device desires to purchase a digital copy of the content of a currently playing media file within the localized physical establishment.

61. The method distributed media selection of claim 42 wherein the received media request is a dedicated media request, the dedicated media request including an indication of at least one third party customer to whom the media selection is dedicated.

62. The method of distributed media selection of claim 61 wherein the indication of the at least one third party customer is conveyed as information chosen from the group consisting of a phone number, an electronic address, and a user name, of the at least one third party customer.

63. The method of distributed media selection system of claim 62 further comprising causing a textual message to be displayed upon the personal portable computing device of the at least one third party customer at the approximate time when the media selection plays within the localized physical establishment associated with the dedicated media request.

64. The method of distributed media selection of claim 63 wherein the textual message includes a textual indication of information chosen from the group consisting of the name, a handle, an electronic address, a phone number, and a unique identifier, of the customer who submitted the dedicated media request.

65. The method of distributed media selection system of claim 42 further comprising compiling a mathematical indication of media file popularity within the localized physical establishment based upon information chosen from the group consisting of a number times the media file is selected for public play within the particular localized physical establishment and the rating data received in response to the public play of the media file within the localized physical establishment.

66. The method of distributed media selection of claim 65 further comprising reporting a representation of the popularity of at least one media file at the physical establishment to the personal portable computing device.

67. A component of an establishment server comprising:
a processor adapted to:
receive a first media request over a network from a first personal portable computing device of a first user, the first media request comprising a first media identifier, a first establishment identifier and a first customer identifier of the first user;
receive a second media request over a network from a second personal portable computing device of a second user, the second media request comprising a second media identifier, a second establishment identifier and a second customer identifier of the second user;
update a first media playlist queue associated with the first establishment identifier, the updating comprising adding a first media file associated with the first media identifier to a listing of media files pending for play within a first localized physical establishment associated with the first establishment identifier;
update a second media playlist queue associated with the second establishment identifier, the updating comprising adding a second media file associated with the second media identifier to a listing of media files pending for play within a second localized physical establishment associated with the second establishment identifier;
cause the output of the contents of the first media file as music at the first localized physical establishment; and
cause the output of the contents of the second media file as music at the second localized physical establishment.

68. The component of the establishment server of claim 67 wherein the first and second portable computing devices are mobile telephone devices.
